(19) United States
(12) Patent Application Publication
(10) Pub. No.: US 2024/0103743 A1
(43) Pub. Date: Mar. 28, 2024

(54) METHODS AND APPARATUS TO STORE DATA BASED ON AN ENVIRONMENTAL IMPACT OF A STORAGE DEVICE

(71) Applicant: Intel Corporation, Santa Clara, CA (US)

(72) Inventors: Francesc Guim Bernat, Barcelona (ES); Karthik Kumar, Chandler, AZ (US); Akhilesh S. Thyagaturu, Tempe, AZ (US); Mario Jose Divan, Hillsboro, OR (US); Matthew Henry Birkner, Las Vegas, NV (US)

(21) Appl. No.: 18/531,395

(22) Filed: Dec. 6, 2023

(51) Int. Cl. G06F 3/06

(52) U.S. Cl. CPC G06F 3/0625; G06F 3/0653; G06F 3/0679

(57) ABSTRACT

Systems, apparatus, articles of manufacture, and methods are disclosed to store data based on an environmental impact of a storage device. An example apparatus to store data, the apparatus includes programmable circuitry to at least one of instantiate or execute the machine readable instructions to determine a first environmental impact associated with storing the data in a first storage device, determine a second environmental impact associated with storing the data in a second storage device, and cause the data to be stored in one of the first storage device or the second storage device based on the first environmental impact and the second environmental impact.

### BACKGROUND

In recent years, edge computing have been implemented to bring computational capabilities and data storage closer to the data source, reducing latency and enhancing real-time processing. Edge nodes collect data from various sensors, devices, or applications in the local environment. The collected data is processed locally on the edge nodes. This processing can include real-time analytics, filtering, aggregation, and other tasks that provide valuable insights. The processed data can be stored on edge storage device. The edge storage infrastructure can be located at or near the edge node. The edge node may include various storage devices, such as hard drives (HDDs), solid-state drives (SSDs) or other storage solutions.

### BRIEF DESCRIPTION OF THE DRAWINGS

FIG. 1 illustrates an overview of an edge cloud configuration for edge computing.

FIG. 2 illustrates operational layers among endpoints, an edge cloud, and cloud computing environments.

FIG. 3 illustrates a block diagram of an example environment for networking and services in an edge computing system.

FIG. 4 illustrates deployment of a virtual edge configuration in an edge computing system operated among multiple edge nodes and multiple tenants.

FIG. 5 illustrates various compute arrangements deploying containers in an edge computing system.

FIG. 6 illustrates an example compute and communication use case involving mobile access to applications in an example edge computing system.

FIG. 7 is an example system in which an example data storage controller operates to store data based on environmental impact.

FIG. 8 is a block diagram of an example implementation of the data storage controller of FIG. 7.

FIG. 9 is a flowchart representative of example machine readable instructions and/or example operations that may be executed, instantiated, and/or performed by example programmable circuitry to implement the data storage controller of FIG. 8.

FIG. 10 is a flowchart representative of example machine readable instructions and/or example operations that may be executed, instantiated, and/or performed by example programmable circuitry to implement the data consumption analysis circuitry of FIG. 8.

FIG. 11 is a block diagram of an example processing platform including programmable circuitry structured to execute, instantiate, and/or perform the example machine readable instructions and/or perform the example operations of FIGS. 9-10 to implement the data storage controller of FIG. 8.

FIG. 12 is a block diagram of an example implementation of the programmable circuitry of FIG. 11.

FIG. 13 is a block diagram of another example implementation of the programmable circuitry of FIG. 11.

FIG. 14 is a block diagram of an example software/firmware/instructions distribution platform (e.g., one or more servers) to distribute software, instructions, and/or firmware (e.g., corresponding to the example machine readable instructions of FIGS. 9-10) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

A distributed data lake is used to store, manage, and analyze data in a distributed and scalable manner. An energy proportional infrastructure (EPI) can be used to support the distributed data lake to ensure that the data lake has efficient energy consumption and is capable of scaling resources as needed to handle data processing workloads. Energy proportionality is a measure of the relationship between power consumed in a computer system, and the rate at which work is done (e.g., utilization). Hence, the EPI refers to a design and management approach for edge computing devices that aims to ensure that energy consumption scales with workload demand. The EPI is designed to use less power when the workload is low and use more power when the workload is high. This approach reduces energy waste and operating costs in edge computing devices. EPI may involve using energy-efficient hardware, dynamic resource allocation, and/or power management techniques to control energy consumption based on the computing needs of the system. EPI may also incorporate power management features, such as decreasing power to idle components or powering down unused servers during period of low activity. Efficient management of a distributed data lake reduces operational costs and contributes to environmental sustainability.

In edge computing, an edge node is a computing device located at the edge of a network close to where data is generated or collected. The edge node collects data from various sensors, devices, or internet-of-things (IoT) endpoints at the edge of the network. The edge node processes the received data locally to reduce latency and improve real-time processing. The edge node performs the preliminary data processing, filtering and/or aggregation before transmitting the data to a central location like a data center or cloud for further analysis and storage.

The environmental impact of distributed data lakes, like any data storage and processing infrastructure, can be significant due to the energy consumption associated with edge device operations, cooling requirements, and other supporting systems. One of the environmental impacts from distributed data lakes is the contribution to greenhouse gas emissions. Carbon dioxide (CO₂) equivalent is a unit of measurement that expresses the impact of various greenhouse gases, such as CO₂, methane (CH₄), nitrous oxide (N₂O), and other greenhouse gases, in terms of the global warming potential of one unit of CO₂ over a specified time period. One aspect of a data center hosting data lakes that contributes to negative environmental impacts is the use of storage to store data at edge devices. The amount of CO₂ emissions (or carbon emissions) and other greenhouse gas emissions caused by the creation and/or use of storage components, including electricity generation and/or cooling, can be significant. The carbon footprint (e.g., the carbon emissions and the CO₂ equivalent) of edge devices have a direct impact on climate change.

Another environmental impact from distributed data lakes is e-waste generation. The cycle of hardware upgrades and replacements in edge devices can lead to electronic waste, which, if not managed properly can harm the environment. Improper disposal of electronic waste generated by edge devices can lead to environmental contamination and/or harm to communities near waste disposal sites. Additionally, data lakes can lead to resource inefficiency if not properly managed, with redundant data storage and underutilized resources. A server that has low utilization can result in underused resources, leading to inefficient energy consumption.

Another environmental impact caused by data lakes is the inefficient handling of raw or unprocessed data in a data lake. When a data lake has inadequate governance and data ingestion policies, it can result in excessive and redundant data being ingested into the data lake. Storing unnecessary data wastes storage capacity and resources. Without proper coordination, redundant data copies can accumulate within the data lake. This redundancy leads to increased storage requirements. Duplicate records or incomplete data can also lead to data wastage, as the data may need to be cleaned, corrected, or discarded, which require additional processing resources. Further, inefficient data processing can consume unnecessary computing resources and time, leading to inefficiencies and increased operational costs. The absence of clear data retention policies can also lead to accumulation of outdated or irrelevant data within the data lake, which consumes storage capacity and impacts data lake performance. Ineffective data lifecycle management practices contribute to data wastage and negative impact on energy and storage resources.

Human activities associated with the generation and/or operation of edge devices can contribute to social and/or political impact. For example, the unethical practices in managing people in the generation of storage devices included in edge devices can have negative social and environmental impacts. Engaging in exploitative labor practices, such as underpaying workers or disregarding labor laws, can harm employee well-being, and lead to labor disputes.

Promoting environmental sustainability in data lake operations can reduce the environmental footprint and/or the social impact associated with data storage and processing. Monitoring and properly maintaining data in data lakes prevent inefficiencies, reduce data waste, and reduce the environmental impact. Examples disclosed herein describes a system to mitigate an environmental, social, and/or political impact from a data lake by determining where to store data based on the least amount of environmental, social, and/or political impact of the available storage devices. For example, examples disclosed herein describes techniques to dynamically allocate data to an appropriate data storage resource to help improve server utilization, reduce the energy consumption, and/or reduce carbon emissions and CO₂ equivalent associated with underutilized hardware. Along with effective data lifecycle management practices, the examples disclosed herein reduce data wastage, and/or the energy and storage resources to store and process data.

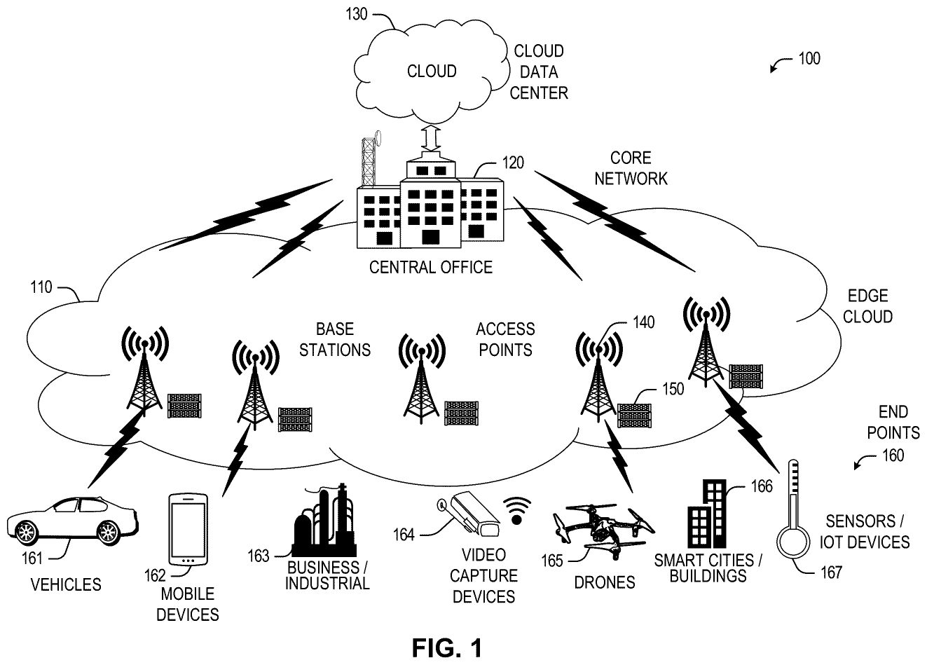

FIG. 1 is a block diagram 100 showing an overview of a configuration for edge computing, which includes a layer of processing referred to in many of the following examples as an “edge cloud.” As shown, the edge cloud 110 is co-located at an edge location, such as an access point, base station, or access device 140, a local processing hub 150, or a central office 120, and thus may include multiple entities, devices, and equipment instances. The edge cloud 110 is located much closer to the endpoint (consumer and producer) data sources and/or end points 160 (e.g., autonomous vehicles 161, user equipment 162, business and industrial equipment 163, video capture devices 164, drones 165, smart cities and building devices 166, sensors and IoT devices 167, Consumer/Customer Presence Equipment 168, etc.) than the cloud data center 130. The Consumer/Customer Presence Equipment 168 may include a gateway or home edge device. In some examples, the mobile device 162, the vehicle 161, the IoT devices 167, a home computing device, etc. may connect with the CPE 168. Compute, memory, and storage resources which are offered at the edges in the edge cloud 110 are critical to providing ultra-low latency response times for services and functions used by the endpoint data sources 160 as well as reduce network backhaul traffic from the edge cloud 110 toward cloud data center 130 thus improving energy consumption and overall network usages among other benefits. In some examples, the end points 160 may be included in the edge cloud 110 as part of a near edge of the edge cloud 110.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the amount of resources needed for network services, through the distribution of more resources which are located closer both geographically and in network access time. In this manner, edge computing attempts to bring the compute resources to the workload data where appropriate or bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “device edge,” “near edge”, “close edge”, “local edge”, “middle edge”, “user device edge,” or “far edge” layers, depending on latency, distance, and timing characteristics.

Edge computing is a developing paradigm where computing is performed at or closer to the “edge” of a network, typically through the use of a compute platform (e.g., x86 or ARM compute hardware architecture) implemented at base stations, gateways, network routers, or other devices which are much closer to endpoint devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

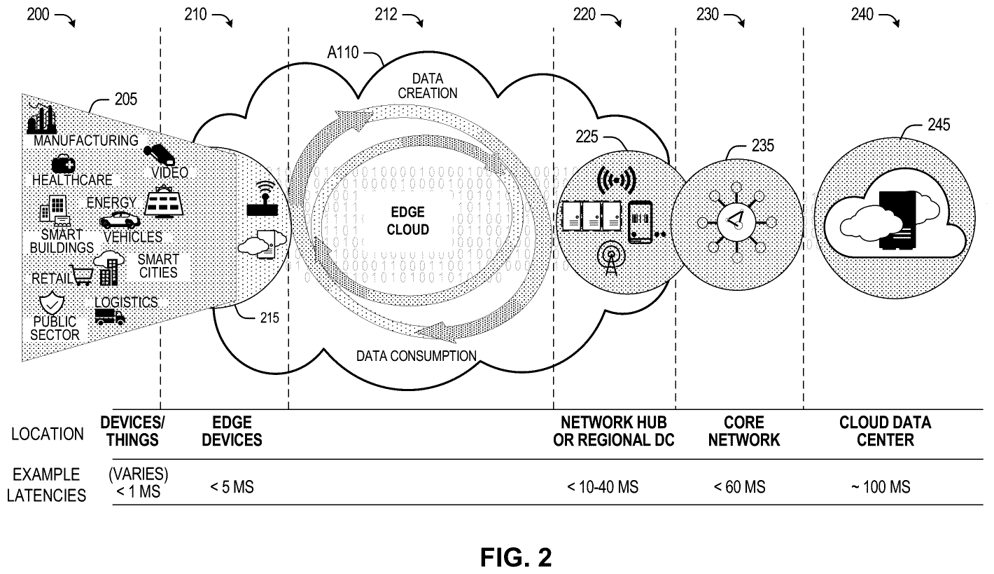

FIG. 2 illustrates operational layers among endpoints, an edge cloud, and cloud computing environments. Specifically, FIG. 2 depicts examples of computational use cases 205, utilizing the edge cloud 110 among multiple illustrative layers of network computing. The layers begin at an endpoint (devices and things) layer 200, which accesses the edge cloud 110 to conduct data creation, analysis, and data consumption activities. The edge cloud 110 may span multiple network layers, such as an edge devices layer 210 having gateways, on-premise servers, or network equipment (nodes 215) located in physically proximate edge systems; a network access layer 220, encompassing base stations, radio processing units, network hubs, regional data centers (DC), or local network equipment (equipment 225); and any equipment, devices, or nodes located therebetween (in layer 212, not illustrated in detail). The network communications within the edge cloud 110 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 200, under 5 ms at the edge devices layer 210, to even between 10 to 40 ms when communicating with nodes at the network access layer 220. Beyond the edge cloud 110 are core network 230 and cloud data center 240 layers, each with increasing latency (e.g., between 50-60 ms at the core network layer 230, to 100 or more ms at the cloud data center layer). As a result, operations at a core network data center 235 or a cloud data center 245, with latencies of at least 50 to 100 ms or more, will not be able to accomplish many time-critical functions of the use cases 205. Each of these latency values are provided for purposes of illustration and contrast; it will be understood that the use of other access network mediums and technologies may further reduce the latencies. In some examples, respective portions of the network may be categorized as “device edge”, “close edge”, “local edge”, “near edge”, “middle edge”, or “far edge” layers, relative to a network source and destination. For instance, from the perspective of the core network data center 235 or a cloud data center 245, a central office or content data network may be considered as being located within a “near edge” layer (“near” to the cloud, having high latency values when communicating with the devices and endpoints of the use cases 205), whereas an access point, base station, on-premise server, or network gateway may be considered as located within a “far edge” layer (“far” from the cloud, having low latency values when communicating with the devices and endpoints of the use cases 205). It will be understood that other categorizations of a particular network layer as constituting a “close”, “local”, “near”, “middle”, or “far” edge may be based on latency, distance, number of network hops, or other measurable characteristics, as measured from a source in any of the network layers 200-240.

The various use cases 205 may access resources under usage pressure from incoming streams, due to multiple services utilizing the edge cloud. To achieve results with low latency, the services executed within the edge cloud 110 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to service level agreement (SLA) or service level objective (SLO), the system as a whole (components in the transaction) may provide the ability to (1) understand the impact of the SLA/SLO violation, and (2) augment other components in the system to resume overall transaction SLA/SLO, and (3) implement operations to remediate.

Thus, with these variations and service features in mind, edge computing within the edge cloud 110 may provide the ability to serve and respond to multiple applications of the use cases 205 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), standard processes, etc.), which cannot leverage conventional cloud computing due to latency or other limitations.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required because edge locations may be unmanned and may even need permissioned access (e.g., when housed in a third-party location). Such issues are magnified in the edge cloud 110 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 110 (network layers 200-240), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 110.

As such, the edge cloud 110 is formed from network components and functional features operated by and within edge gateway nodes, edge aggregation nodes, or other edge compute nodes among network layers 210-230. The edge cloud 110 thus may be embodied as any type of network that provides edge computing and/or storage resources which are proximately located to radio access network (RAN) capable endpoint devices (e.g., mobile computing devices, IoT devices, smart devices, etc.), which are discussed herein. Additionally or alternatively, the edge cloud 110 may be a home network that is connected to the edge and/or could via a FIOS link or a cable network. In other words, the edge cloud 110 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 4G/5G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

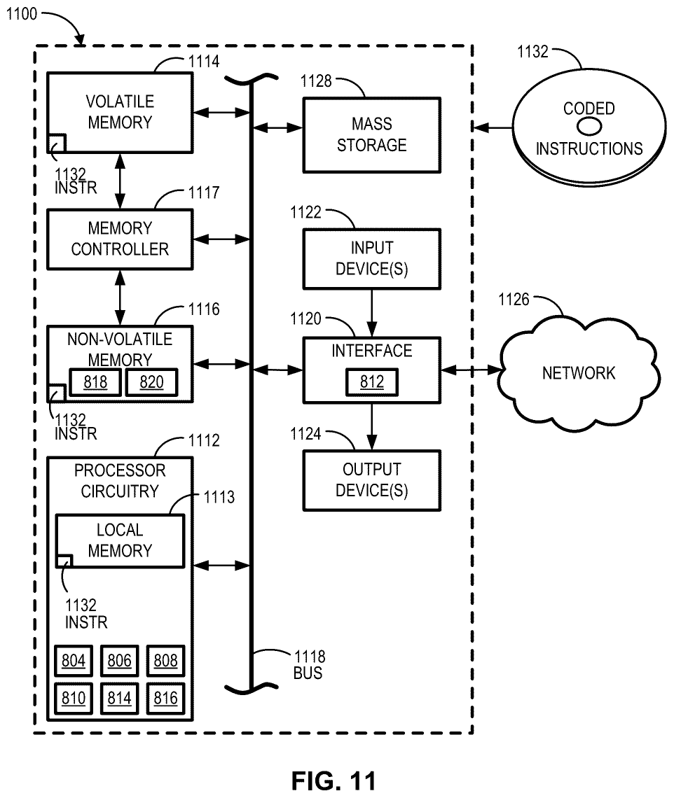

The network components of the edge cloud 110 may be servers, multi-tenant servers, appliance computing devices, set up, home gateway, client workstation, client mobile personal computer (PC), smart phone, and/or any other type of computing devices. For example, the edge cloud 110 may be an appliance computing device that is a self-contained processing system including a housing, case, or shell. In some cases, edge devices are devices presented in the network for a specific purpose (e.g., a traffic light), but that have processing or other capacities that may be harnessed for other purposes. Such edge devices may be independent from other networked devices and provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIG. 11. The edge cloud 110 may also include one or more servers and/or one or more multi-tenant servers. Such a server may implement a virtual computing environment such as a hypervisor for deploying virtual machines, an operating system that implements virtual execution environments, etc. Such virtual computing environments provide an execution environment in which one or more applications may execute while being isolated from one or more other applications.

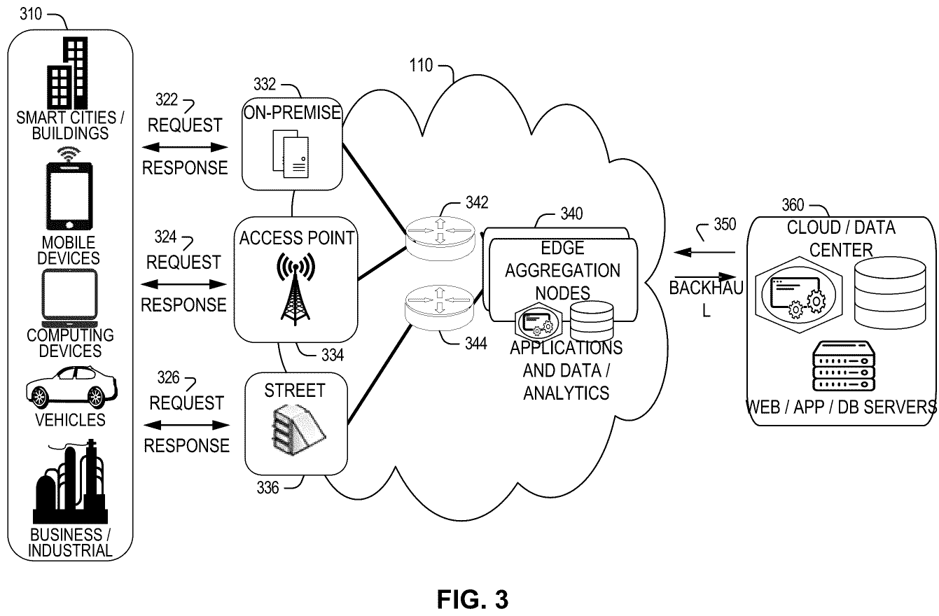

FIG. 3 illustrates a block diagram of an example environment 300 in which various client endpoints 310 (in the form of mobile devices, computers, autonomous vehicles, business computing equipment, industrial processing equipment) exchange requests and responses with the example edge cloud 110. For instance, client endpoints 310 may obtain network access via a wired broadband network, by exchanging requests and responses 322 through an on-premise network system 332. Some client endpoints 310, such as mobile computing devices, may obtain network access via a wireless broadband network, by exchanging requests and responses 324 through an access point (e.g., cellular network tower) 334. Some client endpoints 310, such as autonomous vehicles may obtain network access for requests and responses 326 via a wireless vehicular network through a street-located network system 336. However, regardless of the type of network access, the TSP may deploy aggregation points 342, 344 within the edge cloud 110 to aggregate traffic and requests. Thus, within the edge cloud 110, the TSP may deploy various compute and storage resources, such as at edge aggregation nodes 340, to provide requested content. The edge aggregation nodes 340 and other systems of the edge cloud 110 are connected to a cloud or data center 360, which uses a backhaul network 350 to fulfill higher-latency requests from a cloud/data center for websites, applications, database servers, etc. Additional or consolidated instances of the edge aggregation nodes 340 and the aggregation points 342, 344, including those deployed on a single server framework, may also be present within the edge cloud 110 or other areas of the TSP infrastructure.

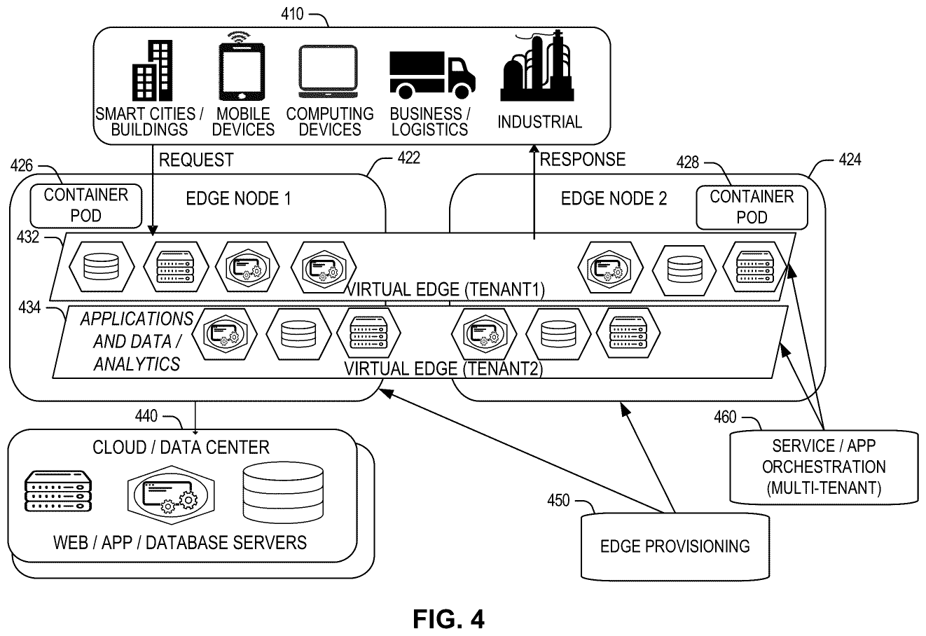

FIG. 4 illustrates deployment and orchestration for virtual edge configurations across an edge computing system operated among multiple edge nodes and multiple tenants. Specifically, FIG. 4 depicts coordination of a first edge node 422 and a second edge node 424 in an edge computing system 400, to fulfill requests and responses for various client endpoints 410 (e.g., smart cities/building systems, mobile devices, computing devices, business/logistics systems, industrial systems, etc.), which access various virtual edge instances. Here, the virtual edge instances 432, 434 provide edge compute capabilities and processing in an edge cloud, with access to a cloud/data center 440 for higher-latency requests for websites, applications, database servers, etc. However, the edge cloud enables coordination of processing among multiple edge nodes for multiple tenants or entities.

In the example of FIG. 4, these virtual edge instances include: a first virtual edge 432, offered to a first tenant (Tenant 1), which offers a first combination of edge storage, computing, and services; and a second virtual edge 434, offering a second combination of edge storage, computing, and services. The virtual edge instances 432, 434 are distributed among the edge nodes 422, 424, and may include scenarios in which a request and response are fulfilled from the same or different edge nodes. The configuration of the edge nodes 422, 424 to operate in a distributed yet coordinated fashion occurs based on edge provisioning functions 450. The functionality of the edge nodes 422, 424 to provide coordinated operation for applications and services, among multiple tenants, occurs based on orchestration functions 460.

It should be understood that some of the devices 410 are multi-tenant devices where Tenant 1 may function within a tenant1 ‘slice’ while a Tenant 2 may function within a tenant2 ‘slice’ (and, in further examples, additional or sub-tenants may exist; and each tenant may even be specifically entitled and transactionally tied to a specific set of features all the way day to specific hardware features). A trusted multi-tenant device may further contain a tenant-specific cryptographic key such that the combination of key and slice may be considered a “root of trust” (RoT) or tenant specific RoT. A RoT may further be computed dynamically composed using a DICE (Device Identity Composition Engine) architecture such that a single DICE hardware building block may be used to construct layered trusted computing base contexts for layering of device capabilities (such as a Field Programmable Gate Array (FPGA)). The RoT may further be used for a trusted computing context to enable a “fan-out” that is useful for supporting multi-tenancy. Within a multi-tenant environment, the respective edge nodes 422, 424 may operate as security feature enforcement points for local resources allocated to multiple tenants per node. Additionally, tenant runtime and application execution (e.g., in instances 432, 434) may serve as an enforcement point for a security feature that creates a virtual edge abstraction of resources spanning potentially multiple physical hosting platforms. Finally, the orchestration functions 460 at an orchestration entity may operate as a security feature enforcement point for marshalling resources along tenant boundaries.

Edge computing nodes may partition resources (memory, central processing unit (CPU), graphics processing unit (GPU), interrupt controller, input/output (I/O) controller, memory controller, bus controller, etc.) where respective partitioning may contain a RoT capability and where fan-out and layering according to a DICE model may further be applied to Edge Nodes. Cloud computing nodes consisting of virtual execution environments, FaaS engines, Servlets, servers, or other computation abstraction may be partitioned according to a DICE layering and fan-out structure to support a RoT context for each. Accordingly, the respective devices 410, 422, and 440 spanning RoTs may coordinate the establishment of a distributed trusted computing base (DTCB) such that a tenant-specific virtual trusted secure channel linking all elements end to end can be established.

Further, it will be understood that a virtual execution environment (e.g., a container, a virtual machine, etc.) may have data or workload specific keys protecting its content from a previous edge node. As part of migration of a virtual execution environment, a pod controller at a source edge node may obtain a migration key from a target edge node pod controller where the migration key is used to wrap the virtual execution environment-specific keys. When the virtual execution environment/pod is migrated to the target edge node, the unwrapping key is exposed to the pod controller that then decrypts the wrapped keys. The keys may now be used to perform operations on virtual execution environment specific data. The migration functions may be gated by properly attested edge nodes and pod managers (as described above).

In further examples, an edge computing system is extended to provide for orchestration of multiple applications through the use of virtual execution environments (deployable execution environment that provides code and needed dependencies to execute instructions (e.g., a program)) in a multi-owner, multi-tenant environment. A multi-tenant orchestrator may be used to perform key management, trust anchor management, and other security functions related to the provisioning and lifecycle of the trusted ‘slice’ concept in FIG. 4. For instance, an edge computing system may be configured to fulfill requests and responses for various client endpoints from multiple virtual edge instances (and, from a cloud or remote data center). The use of these virtual edge instances may support multiple tenants and multiple applications (e.g., augmented reality (AR)/virtual reality (VR), enterprise applications, content delivery, gaming, compute offload) simultaneously. Further, there may be multiple types of applications within the virtual edge instances (e.g., normal applications; latency sensitive applications; latency-critical applications; user plane applications; networking applications; etc.). The virtual edge instances may also be spanned across systems of multiple owners at different geographic locations (or respective computing systems and resources which are co-owned or co-managed by multiple owners).

For instance, each of the edge nodes 422, 424 may implement the use of virtual execution environments, such as with the use of a virtual execution environment (VEE) “pod” 426, 428 providing a group of one or more virtual execution environments. In a setting that uses one or more virtual execution environment pods, a pod controller or orchestrator is responsible for local control and orchestration of the virtual execution environments in the pod. Various edge node resources (e.g., storage, compute, services, depicted with hexagons) provided for the respective edge slices 432, 434 are partitioned according to the needs of each virtual execution environment.

With the use of virtual execution environment pods, a pod controller oversees the partitioning and allocation of virtual execution environments and resources. The pod controller receives instructions from an orchestrator (e.g., the orchestrator 460) that instructs the controller on how best to partition physical resources and for what duration, such as by receiving key performance indicator (KPI) targets based on SLA contracts. The pod controller determines which virtual execution environment requires which resources and for how long in order to complete the workload and satisfy the SLA. The pod controller also manages virtual execution environment lifecycle operations such as: creating the virtual execution environment, provisioning it with resources and applications, coordinating intermediate results between multiple virtual execution environments working on a distributed application together, dismantling virtual execution environments when workload completes, and the like. Additionally, a pod controller may serve a security role that prevents assignment of resources until the right tenant authenticates or prevents provisioning of data or a workload to a virtual execution environment until an attestation result is satisfied.

Also, with the use of virtual execution environment pods, tenant boundaries can still exist but in the context of each pod of virtual execution environments. If each tenant specific pod has a tenant specific pod controller, there will be a shared pod controller that consolidates resource allocation requests to avoid typical resource starvation situations. Further controls may be provided to ensure attestation and trustworthiness of the pod and pod controller. For instance, the orchestrator 460 may provision an attestation verification policy to local pod controllers that perform attestation verification. If an attestation satisfies a policy for a first tenant pod controller but not a second tenant pod controller, then the second pod could be migrated to a different edge node that does satisfy it. Alternatively, the first pod may be allowed to execute, and a different shared pod controller is installed and invoked prior to the second pod executing.

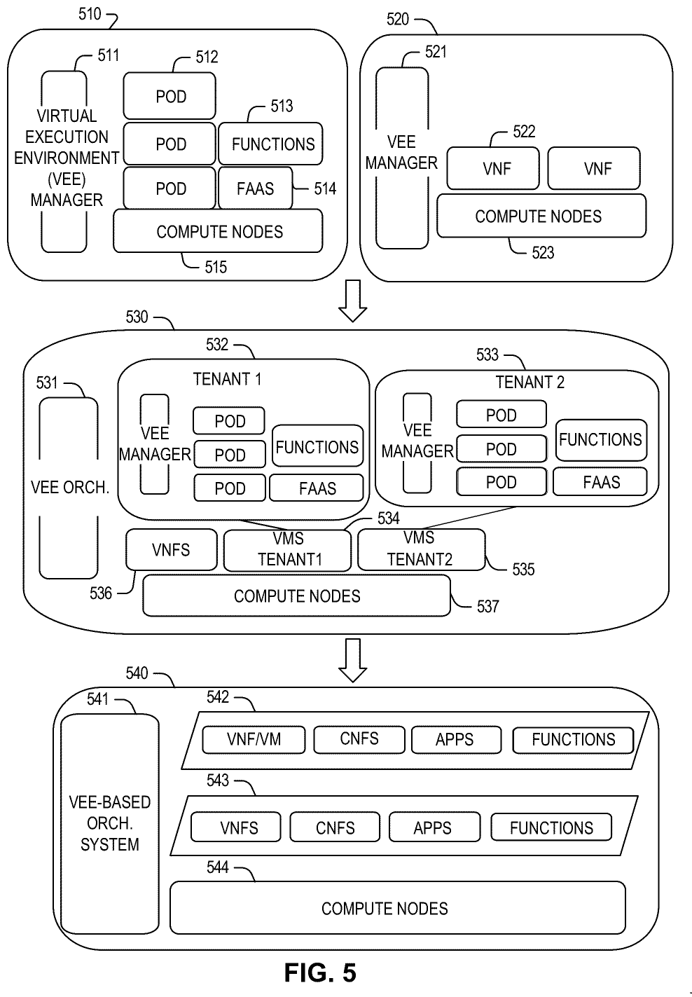

FIG. 5 illustrates additional compute arrangements deploying virtual execution environments in an edge computing system. As a simplified example, system arrangements 510, 520 depict settings in which a pod controller (e.g., virtual execution environment (VEE) managers 511, 521, and a virtual execution environment (VEE) orchestrator 531) is adapted to launch virtual execution environment pods, functions, and functions-as-a-service instances through execution via compute nodes (515 in arrangement 510), or to separately execute containerized virtualized network functions through execution via compute nodes (523 in arrangement 520). This arrangement is adapted for use of multiple tenants in an example system arrangement 530 (using compute nodes 537), where virtual execution environment pods (e.g., pods 512), functions (e.g., functions 513, VNFs 522, 536), and functions-as-a-service instances (e.g., FaaS instance 514) are launched within virtual machines (e.g., VMs 534, 535 for tenants 532, 533) specific to respective tenants (aside the execution of virtualized network functions). This arrangement is further adapted for use in system arrangement 540, which provides virtual execution environment 542, 543, or execution of the various functions, applications, and functions on compute nodes 544, as coordinated by a virtual execution environment (VEE)-based orchestration system 541.

The system arrangements of depicted in FIG. 5 provides an architecture that treats virtual execution environments (e.g., VMs and/or virtual execution environments equally in terms of application composition (and resulting applications are combinations of these three ingredients). Each ingredient may involve use of one or more accelerator (FPGA, ASIC) components as a local backend. In this manner, applications can be split across multiple edge owners, coordinated by an orchestrator.

In the context of FIG. 5, the pod controller/virtual execution environment manager, virtual execution environment orchestrator, and individual nodes may provide a security enforcement point. However, tenant isolation may be orchestrated where the resources allocated to a tenant are distinct from resources allocated to a second tenant, but edge owners cooperate to ensure resource allocations are not shared across tenant boundaries. Or, resource allocations could be isolated across tenant boundaries, as tenants could allow “use” via a subscription or transaction/contract basis. In these contexts, virtualization, virtual execution environmentalization, enclaves, and hardware partitioning schemes may be used by edge owners to enforce tenancy. Other isolation environments may include bare metal (dedicated) equipment, virtual machines, virtual execution environments, virtual machines on virtual execution environments, or combinations thereof.

In further examples, aspects of software-defined or controlled silicon hardware, and other configurable hardware, may integrate with the applications, functions, and services of an edge computing system. Software defined silicon may be used to ensure the ability for some resource or hardware ingredient to fulfill a contract or service level agreement, based on the ingredient's ability to remediate a portion of itself or the workload (e.g., by an upgrade, reconfiguration, or provision of new features within the hardware configuration itself).

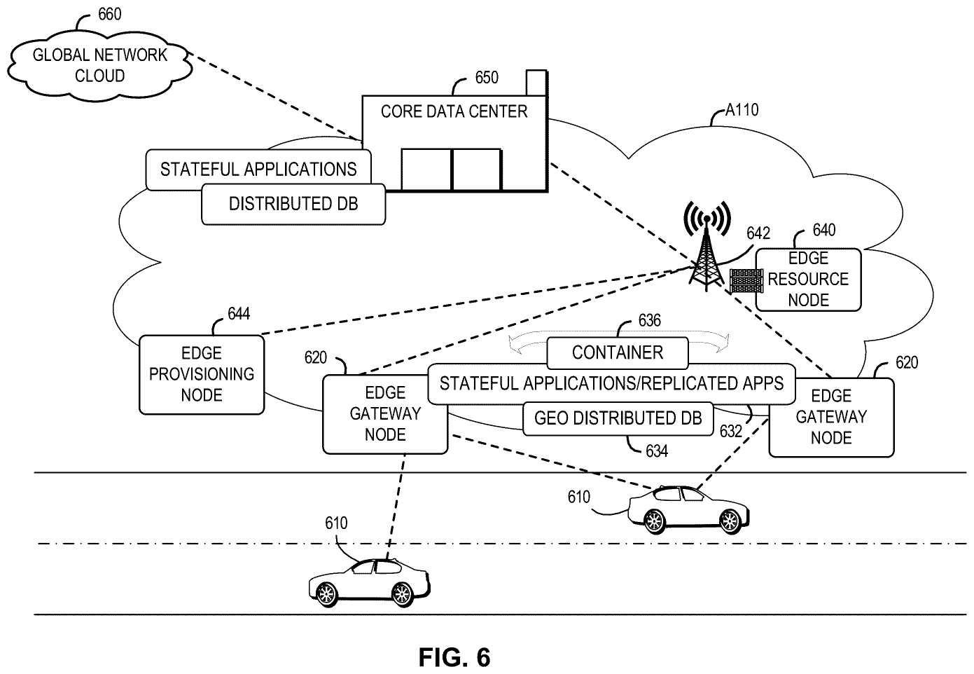

It should be appreciated that the edge computing systems and arrangements discussed herein may be applicable in various solutions, services, and/or use cases involving mobility. As an example, FIG. 6 shows an example simplified vehicle compute and communication use case involving mobile access to applications in an example edge computing system 600 that implements an edge cloud such as the edge cloud 110 of FIG. 1. In this use case, respective client compute nodes 610 may be embodied as in-vehicle compute systems (e.g., in-vehicle navigation and/or infotainment systems) located in corresponding vehicles which communicate with example edge gateway nodes 620 during traversal of a roadway. For instance, the edge gateway nodes 620 may be located in a roadside cabinet or other enclosure built-into a structure having other, separate, mechanical utility, which may be placed along the roadway, at intersections of the roadway, or other locations near the roadway. As respective vehicles traverse along the roadway, the connection between its client compute node 610 and a particular one of the edge gateway nodes 620 may propagate so as to maintain a consistent connection and context for the example client compute node 610. Likewise, mobile edge nodes may aggregate at the high priority services or according to the throughput or latency resolution requirements for the underlying service(s) (e.g., in the case of drones). The respective edge gateway devices 620 include an amount of processing and storage capabilities and, as such, some processing and/or storage of data for the client compute nodes 610 may be performed on one or more of the edge gateway nodes 620.

The edge gateway nodes 620 may communicate with one or more edge resource nodes 640, which are illustratively embodied as compute servers, appliances or components located at or in a communication base station 642 (e.g., a based station of a cellular network). As discussed above, the respective edge resource node(s) 640 include an amount of processing and storage capabilities and, as such, some processing and/or storage of data for the client compute nodes 610 may be performed on the edge resource node(s) 640. For example, the processing of data that is less urgent or important may be performed by the edge resource node(s) 640, while the processing of data that is of a higher urgency or importance may be performed by the edge gateway devices 620 (depending on, for example, the capabilities of each component, or information in the request indicating urgency or importance). Based on data access, data location or latency, work may continue on edge resource nodes when the processing priorities change during the processing activity. Likewise, configurable systems or hardware resources themselves can be activated (e.g., through a local orchestrator) to provide additional resources to meet the new demand (e.g., adapt the compute resources to the workload data).

The edge resource node(s) 640 also communicate with the core data center 650, which may include compute servers, appliances, and/or other components located in a central location (e.g., a central office of a cellular communication network). The example core data center 650 may provide a gateway to the global network cloud 660 (e.g., the Internet) for the edge cloud 110 operations formed by the edge resource node(s) 640 and the edge gateway devices 620. Additionally, in some examples, the core data center 650 may include an amount of processing and storage capabilities and, as such, some processing and/or storage of data for the client compute devices may be performed on the core data center 650 (e.g., processing of low urgency or importance, or high complexity).

The edge gateway nodes 620 or the edge resource node(s) 640 may offer the use of stateful applications 632 and a geographic distributed database 634. Although the applications 632 and database 634 are illustrated as being horizontally distributed at a layer of the edge cloud 110, it will be understood that resources, services, or other components of the application may be vertically distributed throughout the edge cloud (including, part of the application executed at the client compute node 610, other parts at the edge gateway nodes 620 or the edge resource node(s) 640, etc.). Additionally, as stated previously, there can be peer relationships at any level to meet service objectives and obligations. Further, the data for a specific client or application can move from edge to edge based on changing conditions (e.g., based on acceleration resource availability, following the car movement, etc.). For instance, based on the “rate of decay” of access, prediction can be made to identify the next owner to continue, or when the data or computational access will no longer be viable. These and other services may be utilized to complete the work that is needed to keep the transaction compliant and lossless.

In further scenarios, a virtual execution environment (VEE) 636 (or pod of virtual execution environments) may be flexibly migrated from one of the edge nodes 620 to other edge nodes (e.g., another one of edge nodes 620, one of the edge resource node(s) 640, etc.) such that the virtual execution environment with an application and workload does not need to be reconstituted, re-compiled, re-interpreted in order for migration to work. However, in such settings, there may be some remedial or “swizzling” translation operations applied. For example, the physical hardware at the edge resource node(s) 640 may differ from the hardware at the edge gateway nodes 620 and therefore, the hardware abstraction layer (HAL) that makes up the bottom edge of the virtual execution environment will be re-mapped to the physical layer of the target edge node. This may involve some form of late-binding technique, such as binary translation of the HAL from the virtual execution environment native format to the physical hardware format, or may involve mapping interfaces and operations. A pod controller may be used to drive the interface mapping as part of the virtual execution environment lifecycle, which includes migration to/from different hardware environments.

The scenarios encompassed by FIG. 6 may utilize various types of mobile edge nodes, such as an edge node hosted in a vehicle (car/truck/tram/train) or other mobile unit, as the edge node will move to other geographic locations along the platform hosting it. With vehicle-to-vehicle communications, individual vehicles may even act as network edge nodes for other cars, (e.g., to perform caching, reporting, data aggregation, etc.). Thus, it will be understood that the application components provided in various edge nodes may be distributed in static or mobile settings, including coordination between some functions or operations at individual endpoint devices or the edge gateway nodes 620, some others at the edge resource node(s) 640, and others in the core data center 650 or global network cloud 660.

In further configurations, the edge computing system may implement FaaS computing capabilities through the use of respective executable applications and functions. In an example, a developer writes function code (e.g., “computer code” herein) representing one or more computer functions, and the function code is uploaded to a FaaS platform provided by, for example, an edge node or data center. A trigger such as, for example, a service use case or an edge processing event, initiates the execution of the function code with the FaaS platform.

In an example of FaaS, a virtual execution environment is used to provide an environment in which function code (e.g., an application which may be provided by a third party) is executed. The virtual execution environment may be any isolated-execution entity such as a process, a Docker or Kubernetes virtual execution environment, a virtual machine, etc. Within the edge computing system, various datacenter, edge, and endpoint (including mobile) devices are used to “spin up” functions (e.g., activate and/or allocate function actions) that are scaled on demand. The function code gets executed on the physical infrastructure (e.g., edge computing node) device and underlying virtualized virtual execution environments. Finally, virtual execution environment is “spun down” (e.g., deactivated and/or deallocated) on the infrastructure in response to the execution being completed.

Further aspects of FaaS may enable deployment of edge functions in a service fashion, including a support of respective functions that support edge computing as a service (Edge-as-a-Service or “EaaS”). Additional features of FaaS may include: a granular billing component that enables customers (e.g., computer code developers) to pay only when their code gets executed; common data storage to store data for reuse by one or more functions; orchestration and management among individual functions; function execution management, parallelism, and consolidation; management of virtual execution environment and function memory spaces; coordination of acceleration resources available for functions; and distribution of functions between virtual execution environments (including “warm” virtual execution environments, already deployed or operating, versus “cold” which require initialization, deployment, or configuration).

The edge computing system 600 can include or be in communication with an edge provisioning node 644. The edge provisioning node 644 can distribute software such as the example computer readable instructions 1132 of FIG. 11 to various receiving parties for implementing any of the methods described herein. The example edge provisioning node 644 may be implemented by any computer server, home server, content delivery network, virtual server, software distribution system, central facility, storage device, storage node, data facility, cloud service, etc., capable of storing and/or transmitting software instructions (e.g., code, scripts, executable binaries, virtual execution environments, packages, compressed files, and/or derivatives thereof) to other computing devices. Component(s) of the example edge provisioning node 644 may be located in a cloud, in a local area network, in an edge network, in a wide area network, on the Internet, and/or any other location communicatively coupled with the receiving party(ies). The receiving parties may be customers, clients, associates, users, etc. of the entity owning and/or operating the edge provisioning node 644. For example, the entity that owns and/or operates the edge provisioning node 644 may be a developer, a seller, and/or a licensor (or a customer and/or consumer thereof) of software instructions such as the example computer readable instructions 1132 of FIG. 11. The receiving parties may be consumers, service providers, users, retailers, OEMs, etc., who purchase and/or license the software instructions for use and/or re-sale and/or sub-licensing.

In an example, edge provisioning node 644 includes one or more servers and one or more storage devices. The storage devices host computer readable instructions such as the example computer readable instructions 1132 of FIG. 11, as described below. Similarly to edge gateway devices 620 described above, the one or more servers of the edge provisioning node 644 are in communication with a base station 642 or other network communication entity. In some examples, the one or more servers are responsive to requests to transmit the software instructions to a requesting party as part of a commercial transaction. Payment for the delivery, sale, and/or license of the software instructions may be handled by the one or more servers of the software distribution platform and/or via a third party payment entity. The servers enable purchasers and/or licensors to download the computer readable instructions 1132 from the edge provisioning node 644. For example, the software instructions, which may correspond to the example computer readable instructions 1132 of FIG. 11, may be downloaded to the example processor platform/s, which is to execute the computer readable instructions 1132 to implement the methods described herein.

In some examples, the processor platform(s) that execute the computer readable instructions 1132 can be physically located in different geographic locations, legal jurisdictions, etc. In some examples, one or more servers of the edge provisioning node 644 periodically offer, transmit, and/or force updates to the software instructions (e.g., the example computer readable instructions 1132 of FIG. 11) to ensure improvements, patches, updates, etc. are distributed and applied to the software instructions implemented at the end user devices. In some examples, different components of the computer readable instructions 1132 can be distributed from different sources and/or to different processor platforms; for example, different libraries, plug-ins, components, and other types of compute modules, whether compiled or interpreted, can be distributed from different sources and/or to different processor platforms. For example, a portion of the software instructions (e.g., a script that is not, in itself, executable) may be distributed from a first source while an interpreter (capable of executing the script) may be distributed from a second source.

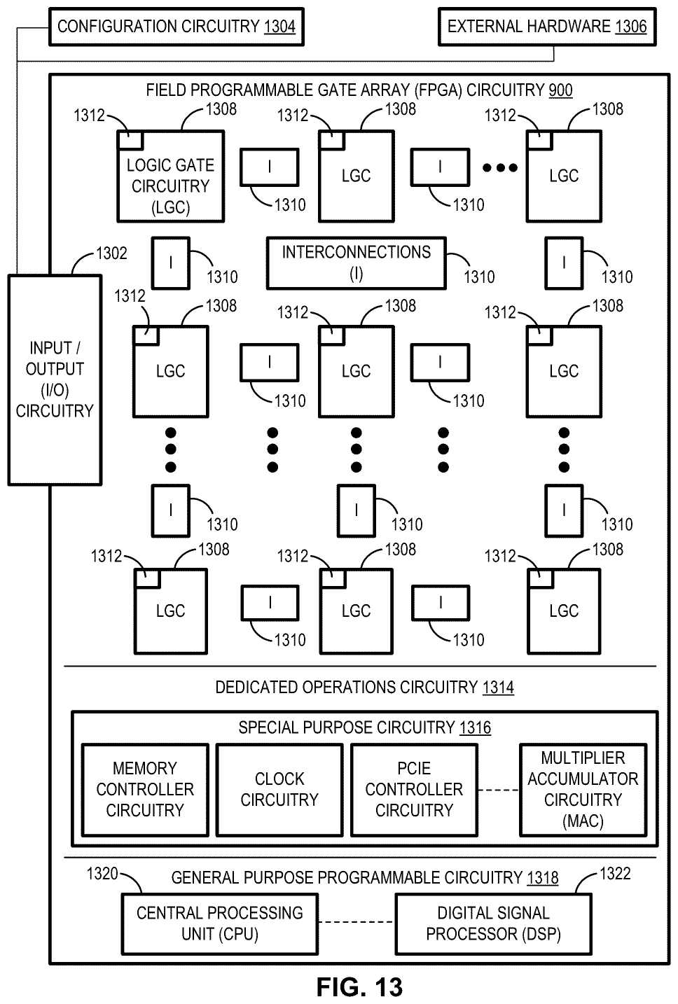

In further examples, any of the compute nodes or devices discussed with reference to the present edge computing systems and environment may be fulfilled based on the components depicted in FIGS. 13A and 13B. Respective edge compute nodes may be embodied as a type of device, appliance, computer, or other “thing” capable of communicating with other edge, networking, or endpoint components. For example, an edge compute device may be embodied as a personal computer, server, smartphone, a mobile compute device, a smart appliance, an in-vehicle compute system (e.g., a navigation system), a self-contained device having an outer case, shell, etc., or other device or system capable of performing the described functions.

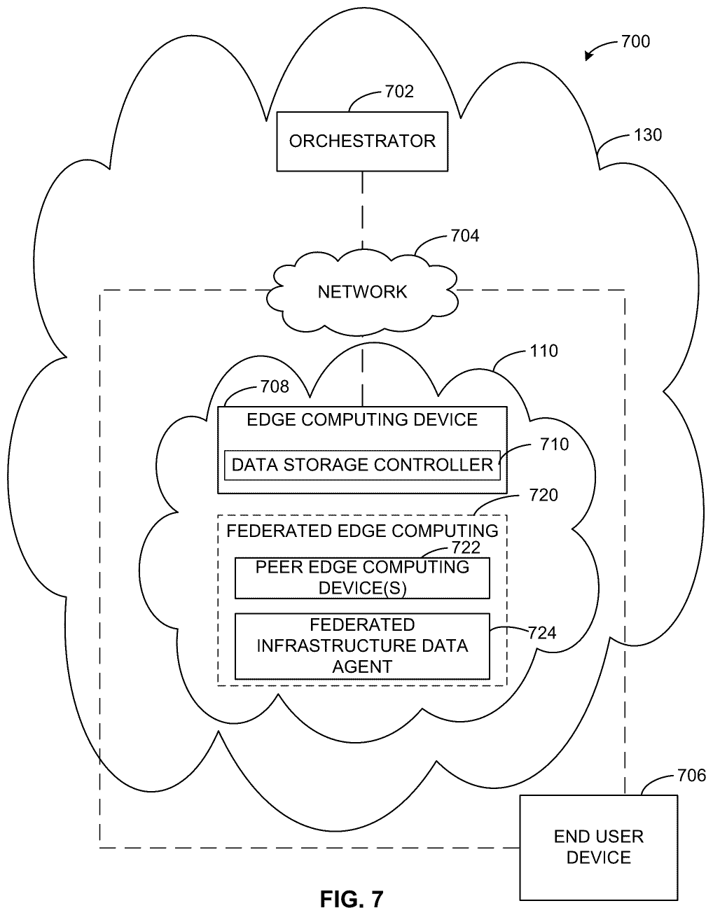

FIG. 7 is a block diagram of an example environment 700 in which an example data storage controller circuitry 710 operates to determine where to store received and/or generated data based on an environmental impact corresponding to one or more storage devices. Although, FIG. 7 is described in conjunction with the environmental impact of the storage device, FIG. 7 may be described in conjunction with an environmental impact, a social impact, and/or a political impact corresponding to one or more the storage devices. The example environment 700 includes the example edge cloud 110 and the example cloud/data center 130 of FIGS. 1, 2, 3, and/or 6. The example environment 700 further includes an example orchestrator 702, an example network 704, an example end user device 706, an example edge computing device 708, and an example federated edge computing device 720 including one or more peer edge computing device(s) 722. Although the example of FIG. 7 corresponds to a cloud-based network, examples disclosed herein can be applied to any type of computing environment (e.g., virtual machines, racks of servers, etc.) and can be deployed anywhere between and/or including the edge computing device 708 up to the cloud 130. In some examples, the cloud/data center 130 corresponds to the cloud/data center 360, 440 of FIGS. 3 and/or 4 and/or the global network cloud 660 of FIG. 6. In some examples, the edge computing device 708 and peer edge computing device(s) 722 may correspond to one or more of the example edge nodes 422, 424, 620, 644 of FIGS. 4 and/or 6. In some examples, the orchestrator 702 may correspond to one or more of the orchestrators 460, 531 of FIGS. 4 and/or 5. Although the example of FIG. 7 includes one orchestrator 702 and one edge computing device 708, there may be any number of clouds and/or edge computing devices. In some examples, the environment 700 may be a low trust or zero trust environment.

The example orchestrator 702 of FIG. 7 is a network device that provides a cloud-based and/or edge-based service. For example, the orchestrator 702 may be a computing device (e.g., a server) that interfaces with the example edge computing device 708 and the peer edge computing device(s) 722 to monitor and/or facilitate operation of connected devices. In some examples, the orchestrator 702 is and/or is implemented by a cloud backend. In some examples, the orchestrator 702 is and/or is implemented by a server that implements and manages VEEs (e.g., virtual machines, containers, and/or servers in a rack). In the example of FIG. 7, the orchestrator 702 is implemented in the cloud-based server 130. The example cloud-based server 130 may be implemented in a private cloud and/or a public cloud. In some examples, the orchestrator 702 is additionally or alternatively implemented in the edge cloud 110.

The example network 704 of FIG. 7 is a system of interconnected systems exchanging data between the orchestrator 702 and processing devices (e.g., the example edge computing device 708, and the example peer edge computing device(s) 722). The example network 704 may be implemented using any type of public or private network such as, but not limited to, the Internet, a telephone network, a local area network (LAN), a cable network, and/or a wireless network. To enable communication via the example network 704, the orchestrator 702, the edge computing device 708 and/or the peer edge computing device(s) 722 includes a communication interface that enables a connection to an Ethernet, a digital subscriber line (DSL), a telephone line, a coaxial cable, and/or any other wired or wireless connection.

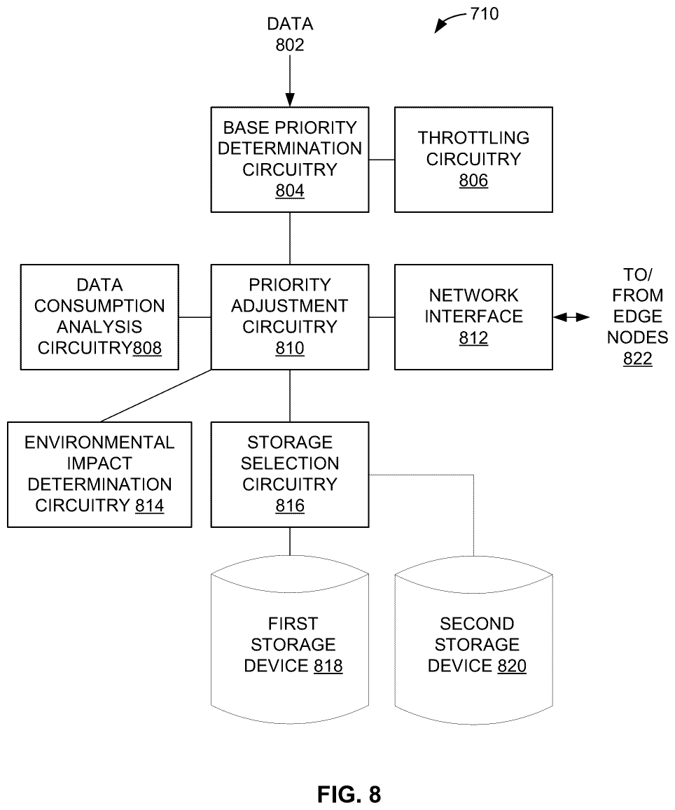

The example edge cloud 110 of FIG. 7 includes the example edge computing device 708, the example data storage controller circuitry 710, the example federated edge computing 720, the example peer edge computing device(s) 722, and the example federated infrastructure data agent 724. The example data storage controller 710 will be described in more detail below in connection with FIG. 8. Although the example of FIG. 7 includes the example edge cloud 110, FIG. 7 may be described in conjunction with a fog domain, and IoT domain, a virtual machine (VM) domain, a multi-access edge computing (MEC) domain, etc.

The example edge computing device 708 of FIG. 7 is a device that operates within the example edge cloud 110. The edge computing device 708 may be a server, a broker, an orchestrator, a fog device, a virtual machine, and/or any other type of computing device operating in a cloud-based environment. In some examples, the edge computing device 708 is a device (e.g., a mobile device, a camera, a drone, a smart device, a sensor, a server, a computer, a IoT device, and/or any other computing device) that interfaces with the example orchestrator 702 to access services of the orchestrator 702 (e.g., directly of via one or more gateway(s), edge device(s), etc.). The example edge computing device 708 can receive incoming data from the end user device 706. In some examples, the end user device 706 may correspond to one of the endpoints 160, 310, 410, of FIGS. 1, 3 and 4. The edge computing device 708 includes the example data storage controller 710 to process the received data and determine where to store the received data based on the environmental impact of the storage device. The example data storage controller 710 is further described below in conjunction with FIG. 8.

The example federated edge computing device 720 of FIG. 7 includes one or more peer edge computing device(s) 722. The example federated edge computing device 720 can be a grouping of edge nodes (a) working on a same or similar workloads, (b) part of the same cluster, etc. In some examples, the peer edge computing device(s) 722 may correspond to one or more of the example edge nodes 422, 424, 620, 644 of FIGS. 4 and/or 6. The example peer edge computing device(s) 722 function similarly to the example edge computing device 708. The example peer edge computing device(s) 722 receive incoming data and store the data in an appropriate storage device based on the environmental impact of the storage device.

The example federated infrastructure data agent 724 of FIG. 7 is a software component responsible for collecting data from various sources (e.g., peer edge computing device(s) 722) within the federated edge computing environment 720. In some examples, the federated infrastructure data agent 724 may be located on one or more of the peer edge computing device(s) 722 to gather data about the local resources, applications, and services running on that edge computing device and/or other edge computing devices. In other examples, the federated infrastructure data agent 724 may be located in a central management node or in the cloud 130, depending on the architecture and requirement of the system. The example federated infrastructure data agent 724 identifies which edge computing devices or edge nodes are similar In some examples, the federated infrastructure data agent 724 identifies similar edge computing device and/or edge nodes based on a k-nearest neighbors (KNN) algorithm. The KNN algorithm is a non-parametric supervised learning classifier, which uses proximity to make classifications or predictions about the grouping of an individual data point. The example federated infrastructure data agent 724 also identifies what data is relevant under what circumstances, to determine what to store in an artificial intelligence (AI) elastic data lake. As used herein, the relevance of data corresponds to how likely that data will be used, accessed, and/or processed by an edge node based on the current circumstances. The AI elastic data lake refers to a data lake with the ability to dynamically scale resources up or down based on demand. An elastic data lake is able to auto-scale infrastructure to efficiently handle varying workloads. An AI data lake encompasses technologies including machine learning, deep learning, natural language processing, computer vision, etc. to extract insights, patterns, and/or predictions from data within a data lake. In some examples, the AI elastic data lake is located in the example cloud 130 and may correspond to one or more of the example data center 360, 440 of FIGS. 3 and/or 4. The example edge computing device may utilize the information (e.g. type of data, type of circumstances and/or the storage device selected for the data) gathered by the example federated infrastructure data agent when deciding where to store the received data.

FIG. 8 is a block diagram of an example implementation of the data storage controller 710 of FIG. 7 to determine a storage device for a received data based on an environmental impact of the storage device. The data storage controller 710 of FIG. 8 may be instantiated (e.g., creating an instance of, bring into being for any length of time, materialize, implement, etc.) by programmable circuitry such as a Central Processor Unit (CPU) executing first instructions. Additionally or alternatively, the data storage controller 710 of FIG. 8 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 8 may, thus, be instantiated at the same or different times. Some or all of the circuitry of FIG. 8 may be instantiated, for example, in one or more threads executing concurrently on hardware and/or in series on hardware. Moreover, in some examples, some or all of the circuitry of FIG. 8 may be implemented by microprocessor circuitry executing instructions and/or FPGA circuitry performing operations to implement one or more virtual machines and/or containers.

The example data storage controller 710 of FIG. 8 includes example base priority determination circuitry 804, example throttling circuitry 806, example data consumption analysis circuitry 808, example priority adjustment circuitry 810, an example network interface 812, example environmental impact determination circuitry 814, example storage selection circuitry 816, an example first storage device 818, and an example second storage device 820. Although the example of FIG. 8 includes two types of storage devices, FIG. 8 may include any number and/or types of storage devices.

The example base priority determination circuitry 804 of FIG. 8 generates a metric identifier (ID) and a base priority value for the data 802 based on a data type of example data 802 (e.g., telemetry data) obtained and/or generated by the edge computing device 708 of FIG. 7. For example, the base priority determination circuitry 804 can process the incoming data 802 to determine the data type (e.g., temperature data, sensor data, processing data, etc.) of the incoming data 802. The data type may be based on where the data was obtained from and/or may be included with the incoming data 802 (e.g., in metadata). The base priority determination circuitry 804 assigns a metric ID that corresponds to the determined data type. The metric ID may correspond to a base priority value. For example, a metric ID for telemetry data corresponding to a particular temperature sensor may have a base priority value of 60. The example base priority determination circuitry 804 passes the base priority value and/or metric ID to an example priority adjustment circuitry 810 to further process the data 802.

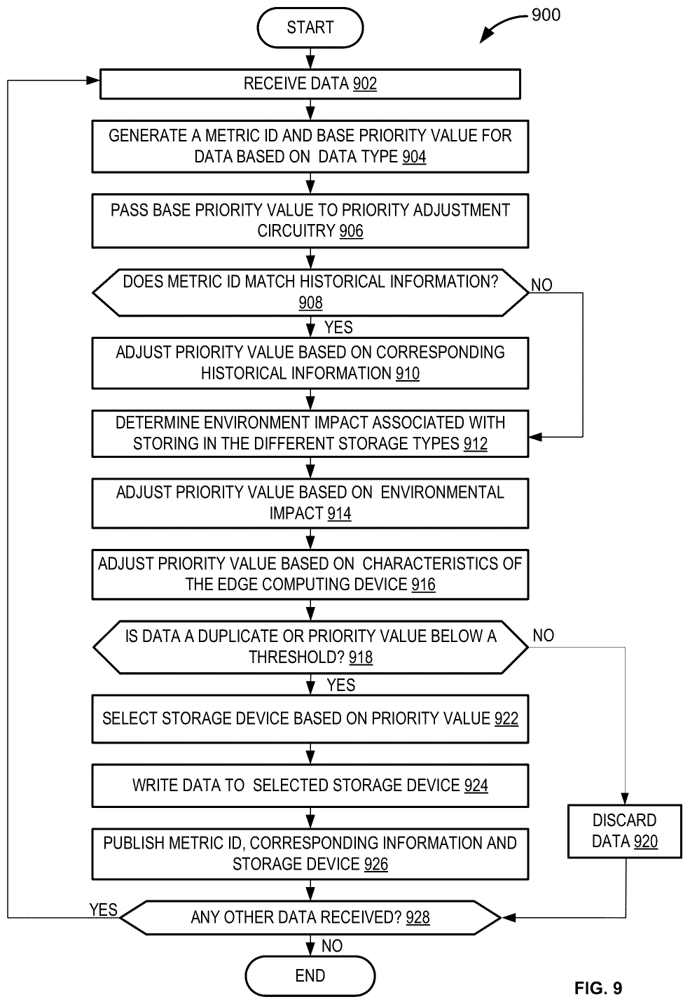

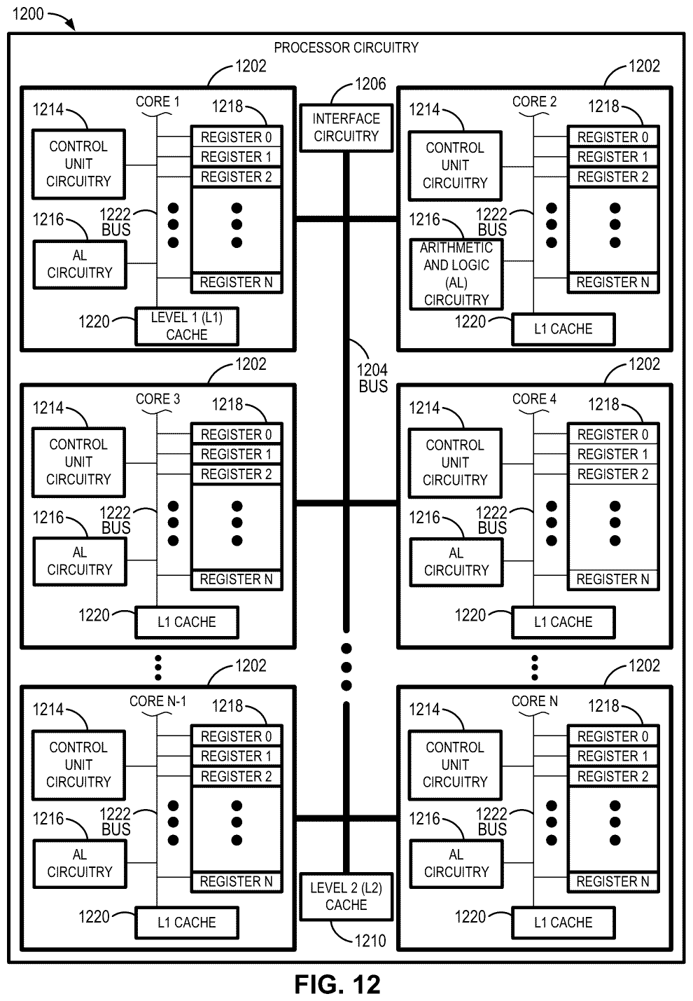

In some examples, the data storage controller 710 includes means for generating a metric identifier and base priority value for data. For example, the means for generating may be implemented by the base priority determination circuitry 804. In some examples, the base priority determination circuitry 804 may be instantiated by programmable circuitry such as the example programmable circuitry 1112 of FIG. 11. For instance, the base priority determination circuitry 804 may be instantiated by the example microprocessor 1200 of FIG. 12 executing machine executable instructions such as those implemented by at least blocks 904, 906, 920, 928 of FIG. 9. In some examples, the base priority determination circuitry 804 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the base priority determination circuitry 804 may be instantiated by any other combination of hardware, software, and/or firmware. For example, the base priority determination circuitry 804 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example throttling circuitry 806 of FIG. 8 determines if energy throttling is required to reduce the energy consumption of the edge computing device 708 to meet certain carbon credits, also known as carbon offsets. Carbon credits represent a reduction or removal of a certain amount of carbon or greenhouse gases from the atmosphere. In some examples, the example throttling circuitry 806 may reduce the power consumption of servers during periods of low demand to save on energy costs. Additionally or alternatively, when the system does not have full scale resources to consume and/or process the data 802, the example throttling circuitry 806 can throttle energy to the edge computing device 708.

The example data consumption analysis circuitry 808 of FIG. 8 determines whether the received data 802 corresponds to historical data. The historical data can include data from the federated group of peer edge computing device(s) 722. Additionally or alternatively, the historical data can include data related to previously stored data. The historical data provide hints to the example data consumption analysis circuitry 808 on the likelihood that the data 802 will be used (e.g., processed and/or consumed by the edge computing device 708) sooner or later (e.g., based on a threshold amount of time). The historical data includes information related to which storage device previously processed telemetry data was stored in, when, if ever, the previously processed telemetry data was consumed and/or processed after storing, whether the previously processed telemetry data was compressed, information related to the characteristics of the edge computing device when the data was consumed and/or processed after storing, the base and/or adjusted priority value of the previously processed telemetry data, etc. When the priority adjustment circuitry 810 is determining how to adjust the base priority value of the incoming data 802, the data consumption analysis circuitry 808 provides historical data related to the metric ID of the incoming data 802, as further described below.

In some examples, the historical data is created by analyzing and clustering all received data to the edge computing device 708 or the peer edge computing device(s) 722, to help inform decisions on where to store the received data 802. The example data consumption analysis circuitry 808 analyzes the received data 802 generated by the system and represents the data as variables V₁, . . . V_{N} and decides which of those variables are meaningful information with respect to the other information received and which data are not meaningful. This can be implemented using an algorithm such as a principal component analysis (PCA). A PCA is a dimensionality reduction technique used in data analysis to reduce the dimensionality of large data sets, by transforming a large set of variables into a smaller set of variables that still contains most of the information in the large set. The variables V₁, . . . V_{N} that are identified during a particular period of time to be relevant are correlated with contextual variables of the system. Contextual variables Cl, CN include information such as temperature, amount of applications running, state or mode of the edge computing device 708, amount of resources being consumed by the edge computing device 708, type of workloads being executed by the edge computing device 708, etc. The correlations that are analyzed over time are utilized to configure selector circuitry. Selector circuitry is circuitry included in the data consumption analysis circuitry 808 that selects the actual representative variables V₁, . . . V_{N} to be stored in a storage system or data lake based on the contextual variable. The peer edge computing device(s) 722 and corresponding EPI may provide similar rules over time that can be used to configure the selectors. This policy can be implemented across different peer edge computing devices that belong to or are deployed in similar circumstances. The example data consumption analysis circuitry 808 also determines whether the data 802 is critical based on a likelihood that the data 802 will be accessed within a threshold period of time.

Additionally, the example data consumption analysis circuitry 808 of FIG. 8 analyzes the use of stored data to make patterns associated with the likelihood that the received data 802 will be used within a threshold amount of time. The example data consumption analysis circuitry 808 makes the patterns based on the metric ID (e.g., identifier of the data type), and/or information that the data carries. The information that the data 802 carries may provide information to determine the likelihood that the data 802 will be accessed within the threshold amount of time. The example data consumption analysis circuitry 808 clusters the data, for example, using the KNN type algorithm. Additionally, the data consumption analysis circuitry 808 creates a group of data associated with a metric ID, based on the analyzed and clustered information. The example data consumption analysis circuitry 808 publish, via the network interface 812, the metric ID and the corresponding information to other nodes in federation so that other nodes can use the information in their own processing. If a received data 802 is determined to be similar to a historical data, the example data consumption analysis circuitry 808 associates the received data with the stored data group, and the priority adjustment circuitry uses the historical data to adjust the base priority value of the data 802, as further described below.

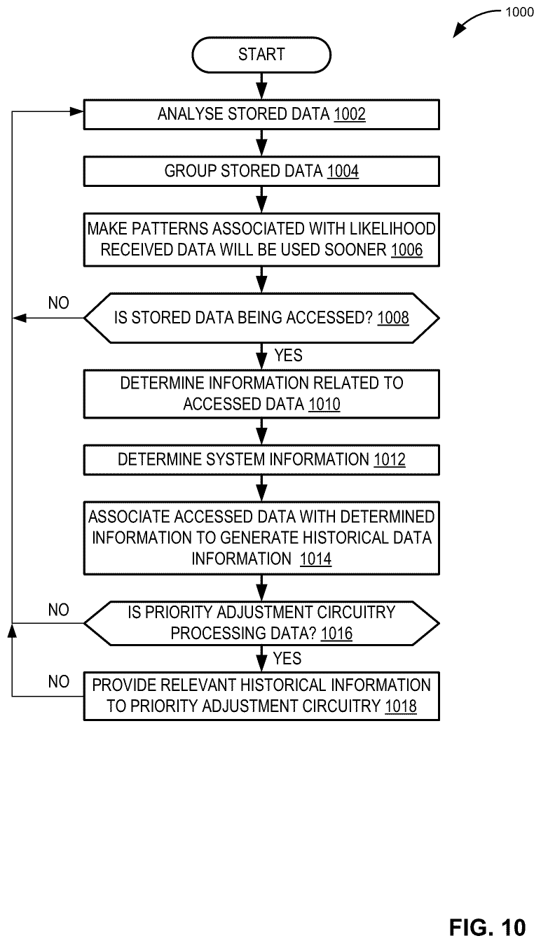

In some examples, the data storage controller 710 includes means for determining that the data corresponds to a stored data. For example, the means for determining may be implemented by the data consumption analysis circuitry 808. In some examples, the data consumption analysis circuitry 808 may be instantiated by programmable circuitry such as the example programmable circuitry 1112 of FIG. 11. For instance, the data consumption analysis circuitry 808 may be instantiated by the example microprocessor 1200 of FIG. 12 executing machine executable instructions such as those implemented by at least blocks 914 of FIG. 9, 1002-1018 of FIG. 10. In some examples, the data consumption analysis circuitry 808 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the data consumption analysis circuitry 808 may be instantiated by any other combination of hardware, software, and/or firmware. For example, the data consumption analysis circuitry 808 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the means for determining that the data corresponds to a stored data includes means for analyzing and clustering stored data to generate historical information.

In some examples, if it is likely that the data 802 will be accessed later (e.g., corresponding to a likelihood that the data will not be used within the threshold amount of time), the data consumption analysis circuitry 808 of FIG. 8 can instruct compression circuitry of the edge computing device 708 to compress the data 802 to reduce storage space. Compressed data can be stored more efficiently and can lead to benefits such as reduced storage costs and faster data transfer speeds. However, when data is compressed, the data needs to be decompressed before it can be used, which introduces a processing overhead and/or latency. The data consumption analysis circuitry 808 may balance the trade-off between compression, storage efficiency, and processing requirements is considered when determining whether to use compression for a particular dataset.

The example priority adjustment circuitry 810 of FIG. 8 adjusts the base priority value of the data 802 based on the metric ID matching a historical information (e.g., corresponding to previously stored data locally or within a federated edge device), and/or environmental impact associated with storing the data in the first storage device 818 or the second storage device 820. The data matching the historical information informs the priority adjustment circuitry 810 of the relevance of the data, and/or criticality of the data. For example, if the data 802 corresponds to previously stored data that was accessed within a threshold amount of time when the edge device was working in a low power mode, the priority adjustment circuitry 810 may increase the base priority to a higher level. In some examples, the example priority adjustment circuitry 810 adjusts the base priority value based on whether the data 802 is relevant or critical. Data relevance is measured in terms of whether the data is correlated with any contextual variables of the system. Data criticality is determined based on whether the data 802 will be used within a threshold amount of time. The priority adjustment circuitry 810 can use the priority value of the data to decide where to store the received data 802.

Additionally or alternatively, the example priority adjustment circuitry 810 of FIG. 8 may prune (e.g., discard, remove, delete, etc.) data that is received. For example, if the data 802 is similar to other recently collected data or is a duplicate, the priority adjustment circuitry 810 may discard the data 802. In some examples, if the priority value of the data 802 is below a threshold value, the example priority adjustment circuitry 810 can discard the data 802. If the priority value of the data 802 is above a threshold value, the priority adjustment circuitry 810 pass the data 802 and the adjusted priority value to an example storage selection circuitry 816 to select a storage device for the data 802 based on the adjusted priority value. Additionally, the example priority adjustment circuitry 810 publish the metric ID associated with the data 802 and the corresponding information and storage device used to store the data 802 to other edge devices with the network interface 812.

Additionally or alternatively, the priority adjustment circuitry 810 of FIG. 8 can adjust the based priority value based on the environmental impact associated with storing the data 802 in the first storage device 818 and/or the second storage device 820. For example, as further described below, the environmental impact determination circuitry 814 can determine the environmental impact (and/or social impact, political, impact, etc.) associated with storing the data 802 into the different storage device types. The priority adjustment circuitry 810 can adjust the priority level of the data 802 based on the determined environmental impacts. For example, a higher environmental impact may reduce the priority level while a lower environmental impact may increase the priority level.

Additionally or alternatively, the priority adjustment circuitry 810 may adjust a priority value of the data 802 based on the characteristics and/or operating mode of the edge computing device 708. For example, if the edge computing device 708 is operating in a sleep or low power mode, the likelihood that the edge computing device 708 will access the data 802 within a threshold amount of time may be lower than when the edge computing device 708 is operating in a full power mode. Accordingly, the priority adjustment circuitry 810 can lower the priority value of the data 802 when the edge computing device 708 is operating in a low power mode. In another example, the edge computing device 708 can adjust the priority value based on the workload currently being executed by the edge computing device 708. For example, some types of workloads may result in the use or more resources than other types of workloads. Thus, the edge computing device 708 may access telemetry data more often while executing particular workload types to ensure that the edge computing device 708 is not working past capacity. Thus, the priority adjustment circuitry 810 can increase the priority when the edge computing device 708 is executing a particular workload.

In some examples, the data storage controller 710 includes means for adjusting the base priority value. For example, the means for adjusting may be implemented by the priority adjustment circuitry 810. In some examples, the priority adjustment circuitry 810 may be instantiated by programmable circuitry such as the example programmable circuitry 1112 of FIG. 11. For instance, the priority adjustment circuitry 810 may be instantiated by the example microprocessor 1200 of FIG. 12 executing machine executable instructions such as those implemented by at least blocks 908, 910, 914, 916, 918, 926 of FIG. 9. In some examples, the priority adjustment circuitry 810 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the priority adjustment circuitry 810 may be instantiated by any other combination of hardware, software, and/or firmware. For example, the priority adjustment circuitry 810 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example network interface 812 of FIG. 8 allows the data storage controller 710 to communicate with other peer edge computing device(s) 722 on the same network. For example, the example network interface 812 can receive and/or obtain information (e.g., related to how other data was stored, details related to access to the other data after stored, priority values of other data, etc.) from peer edge computing device(s) 722 and utilize that information to decide where to store data 802 that the example data storage controller 710 receives. Additionally, the network interface 812 can transmit information related to data processed and/or stored locally (e.g., the priority level of the data 802, where the data 802 is stored, when and/or how often the data 802 is accessed after being stored, characteristics of the edge node device when the data 802 is accessed, etc.). In this manner, other edge devices can use the information to determine how to store obtained data.

The example environmental impact determination circuitry 814 of FIG. 8 determines the environmental impact associated with storing the data 802 in different storage types. As described above, examples of environmental impact includes the storage device energy consumption to store and/or access the data 802, resource consumption to store and/or access the data 802, heat generation from storage device, water usage for cooling the storage device, e-waste generation from continuous upgrading of the storage device, data lifecycle such as aging data (e.g., data that is outdated, less relevant, as it gets older), materials used to generate the storage device, carbon emissions associated with the use and/or generation of the storage device, location of where the storage device is generated vs. where the storage device is implemented (e.g., corresponding to distance the storage device needs to travel to be implemented), energy required to transport the data throughout transport circuitry (e.g., a network interface, a power source, a bus, memory, network, optics components, etc.) of the edge computing device 708 (e.g., a network interface power, bus power, wall power, memory power, network power, optics and/or anything in the path from storage device 818 and/or storage device 820), transportation used to transport the storage device, packaging used to transport the storage device, energy and/or resource consumption of manufacturing facility that generates and/or assembles the storage device, carbon emissions of the manufacturing facilitate that generates and/or assembles the storage device, environmental codes of the facility that generates and/or assembles the storage device, environmental record (e.g., whether the facility has failed any codes) of the facilitate that generates and/or assembles the storage device, and/or any other environmental information related to the generation, transport, and/or use of the storage device. In some examples, the environmental impact determination circuitry 814 additionally or alternatively considers the social and/or political impact associated with the data storage device. For example, the environmental impact determination circuitry 814 can generate a value related to how well the manufacturer of the storage device treats or pays its employees, what issues the manufacturer supports or does not support, political ties of the manufacturer of the storage device, and/or any other social and/or political impact associated with the make, transport, or use of a storage device. The environmental impact determination circuitry 814 transmits the environmental, social, and/or environmental impact information to the example priority adjustment circuitry 810 to adjust the priority value accordingly. In this manner, the storage selection circuitry 816 can determine which storage device to store the data 802 based on the environmental, social, and/or environmental impact associated with storing the data 802.

In some examples, the data storage controller 710 includes means for determining environmental impact associated with storing data in a storage device. For example, the means for determining environmental impact may be implemented by the environmental impact determination circuitry 814. In some examples, the environmental impact determination circuitry 814 may be instantiated by programmable circuitry such as the example programmable circuitry 1112 of FIG. 11. For instance, the environmental impact determination circuitry 814 may be instantiated by the example microprocessor 1200 of FIG. 12 executing machine executable instructions such as those implemented by at least blocks 912 of FIG. 9 In some examples, the environmental impact determination circuitry 814 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the environmental impact determination circuitry 814 may be instantiated by any other combination of hardware, software, and/or firmware. For example, the environmental impact determination circuitry 814 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example storage selection circuitry 816 of FIG. 8 decides where to store a received data 802 based on the data 802 priority value. As described above the priority value of a data is determined by one or more environmental impacts, social impacts, political impacts, data lifecycle, historical data (e.g., obtained locally at the edge computing device 708 or from another edge computing device), based on the characteristics and/or mode of the edge computing device 708, based on workload(s) that the edge computing device 708 is executing, etc. A decision on where to store a data 802 can additionally or alternatively be based on how long the data is needed for, how often the data will be needed, and/or when the data will be needed. For example, the example storage selection circuitry 816 could store a long term data, less accessed data, and/or data that may not be needed for a threshold amount of time in HDD (e.g., which may have a lower environmental, social, and/or political impact) and a short term data, more accessed data, and/or data that may be needed for a threshold amount of time in SSD (e.g., which may have a higher environmental, social, and/or political impact). In some examples, the example storage selection circuitry 816 uses the information corresponding to the type of data and the information the data carriers to direct the data into a storage device that is available or suitable for those data type. Other considerations for the example storage selection circuitry 816 include whether the data 802 needs to be processed immediately, whether the data 802 is used for real-time processing (e.g., auto-pilot of automotive control), whether there are any security concerns for the data 802, and whether the data 802 is tagged as critical and/or relevant. In some examples, the storage selection circuitry 816 makes the storage selection determination based on the priority value output by the priority adjustment circuitry 810. Because the priority value may have been generated and/or adjusted based on the data type, the characteristics and/or mode of the edge computing device, the type of workloads being executed by the edge computing device, the environmental, social, and/or political impacts associated with the storage devices and/or data, and/or historical information, the storage selection circuitry 816 can select the storage device based on the priority level, which considers one or more of the above-referenced factors. In the illustrated example of FIG. 8, the data 802 can be stored in the example first storage device 818 or the example second storage device 820. However, in other systems, there may be additional and/or alternative storage device types that the storage selection circuitry 816 can select from. In the example of FIG. 8, the storage selection circuitry 816 writes (e.g., stores) the data 802 to either the example first storage device 818 or the example second storage device 820.

In some examples, the data storage controller 710 includes means for writing data to the first storage device or the second storage device. For example, the means for writing data may be implemented by the storage selection circuitry 816. In some examples, the storage selection circuitry 816 may be instantiated by programmable circuitry such as the example programmable circuitry 1112 of FIG. 11. For instance, the storage selection circuitry 816 may be instantiated by the example microprocessor 1200 of FIG. 12 executing machine executable instructions such as those implemented by at least blocks 922, 924 of FIG. 9. In some examples, the storage selection circuitry 816 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the storage selection circuitry 816 may be instantiated by any other combination of hardware, software, and/or firmware. For example, the storage selection circuitry 816 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example first storage device 818 and the example second storage device 820 of FIG. 8 are capable of storing the received data 802 by writing the data 802 to the respective storage device(s). The example first storage device 818, and the example second storage device 820 can be implemented by hard drives (HDDs), solid-state drives (SSDs), or any other storage media. The first storage device 818 is a different type of storage device than the second storage device 820. For example, the first storage device 818 may be an HDD and the second storage device 820 may be an SSD. In some examples, HDD drives may consume 4.2 Watts to read and write data, whereas SSD may consume 1.3 Watts. Based on research, 1 terabyte of HDD emits the equivalent of 159 kilogram (kg) of CO₂ during a 10-year operating lifespan. By comparison, a 1 terabyte SSD emits just 49.2 kg over the 10-year lifespan. However, SSDs are significantly more carbon intensive to manufacture because the chip fabrication facilities for SSDs operate at extreme temperatures and pressures that are energy intensive to maintain. Furthermore, bigger memories require more chips, which increases the carbon footprint accordingly. All this factors add up to a significant carbon footprint for SSD manufacture. 1 terabyte of SSD emits the equivalent of 320 kg of CO₂, whereas a similar HDD emits just 40 kg of CO₂. So the lifetime footprint for a 1 terabyte SSD is 369.2 kg of CO₂ equivalent versus 199 kg of CO₂ equivalent for an HDD. Therefore, in such examples, HDD have a lower environmental impact than SSD. However, SSD are faster than HDD. For data that does not need fast access performance (e.g., data that will not be accessed within a threshold amount of time and/or will not be accessed frequently), the data can be stored in a data storage with lower environmental impact without significantly impacting performance. Thus, more data can be stored in lower environmentally impactful storage, which can reduce the need of large SSD devices. Thus, edge devices can implement devices with smaller SSD devices and reduce environmental impact. This trade-off of performance and environmental impact over time can impact how much growth the infrastructure requires to support the data needs, thereby leading to more environmentally friendly edge computing devices. In examples disclosed herein, carbon emission is used to decide storage device for received data. However, any other environmental, social, and/or political impact factors may additionally or alternatively be used to determine a storage device for received data.

The example data storage controller 710 including the example base priority determination circuitry 804, the example throttling circuitry 806, the example priority adjustment circuitry 810, the example data consumption analysis circuitry 808, the example environmental impact determination circuitry 814, and the example storage selection circuitry 816 could be implemented by one or more artificial intelligence (AI)-based models. Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

In general, implementing a ML/AI system involves two phases, a learning/training phase, and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.) Alternatively, unsupervised training (e.g., used in deep learning, a subset of machine learning, etc.) involves inferring patterns from inputs to select parameters for the ML/AI model (e.g., without the benefit of expected (e.g., labeled) outputs).

Training is performed using training data. In examples disclosed herein, the training data originates from publicly available data obtained from the federated edge computing 720 with multiple peer edge computing device(s) 722. Unsupervised training is used by inferring patterns from inputs from the multiple peer edge node 722.

After training is complete, the model is deployed for use as an executable construct that processes an input and provides an output based on the network of nodes and connections defined in the model. The model is stored at the edge computing device 708. The model may then be executed by the data storage controller 710.

In the example of FIG. 8, one or more components of the data storage controller 710 can be trained to perform the above-described tasks based on the corresponding input data. For example, an AI-based model can be trained to adjust a priority value based on environmental impact data and/or historical data. In such an example, training data may include historical data and/or environmental data that is tagged with a particular value. The training data can be applied to the AI-based model to train the AI based model to be able to adjust priority values based on historical and/or environmental data. Accordingly, the priority adjustment circuitry 810 could be implemented by an AI-based model. Similarly, other components of the data storage controller 710 can be implemented by one or more AI-based models using training data specific to the operation of the corresponding component.

While an example manner of implementing the data storage controller 710 of FIG. 7 is illustrated in FIG. 8, one or more of the elements, processes, and/or devices illustrated in FIG. 8 may be combined, divided, re-arranged, omitted, eliminated, and/or implemented in any other way. Further, the example base priority determination circuitry 804, the example throttling circuitry 806, the example data consumption analysis circuitry 808, the example priority adjustment circuitry 810, the example environmental impact determination circuitry 814, the example storage selection circuitry 816 and/or, more generally, the example data storage controller 710 of FIG. 8, may be implemented by hardware alone or by hardware in combination with software and/or firmware. Thus, for example, any of the example base priority determination circuitry 804, the example throttling circuitry 806, the example data consumption analysis circuitry 808, the example priority adjustment circuitry 810, the example environmental impact determination circuitry 814, the example storage selection circuitry 816, and/or, more generally, the example data storage controller 710, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example data storage controller 710 of FIG. 8 may include one or more elements, processes, and/or devices in addition to, or instead of, those illustrated in FIG. 8, and/or may include more than one of any or all of the illustrated elements, processes, and devices.

Flowcharts representative of example machine readable instructions, which may be executed by programmable circuitry to implement and/or instantiate the data storage controller 710 of FIG. 8 and/or representative of example operations which may be performed by programmable circuitry to implement and/or instantiate the data storage controller 710 of FIG. 8, are shown in FIGS. 9-10. The machine readable instructions may be one or more executable programs or portion(s) of one or more executable programs for execution by programmable circuitry such as the programmable circuitry 1112 shown in the example processor platform 1100 discussed below in connection with FIG. 11 and/or may be one or more function(s) or portion(s) of functions to be performed by the example programmable circuitry (e.g., an FPGA) discussed below in connection with FIGS. 12 and/or 13. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 9-10, many other methods of implementing the example data storage controller 710 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 9-10 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 9 is a flowchart representative of example machine readable instructions and/or example operations 900 that may be executed, instantiated, and/or performed by programmable circuitry to implement the data storage controller 710 of FIG. 8 to select a storage device for storing obtained data. The example machine-readable instructions and/or the example operations 900 of FIG. 9 begin at block 902, at which the example network interface 812 (FIG. 8) receives the example data 802 (FIG. 8). In some examples, the data 802 is telemetry data that is collected and/or generated by the edge computing device 708. For example, the telemetry data may correspond to one or more temperatures sensed in the edge computing device 708, the amount of resources (e.g., processing resources, memory resources, bandwidth, disk space, etc.) used by the edge computing device 708.

At block 904, the example base priority determination circuitry 804 (FIG. 8) generates a metric ID and a base priority value for the data 802 based on the data type of the data 802 and/or the information the data 802 carries. For example, the based priority determination circuitry 804 determines a metric ID that is based on the data type and/or information the data 802 carries. The metric ID may be associated with a particular base priority value. Thus, the base priority determination circuitry 804 can determine the base priority value based on the determined metric ID.

At block 906, the example base priority determination circuitry 804 transmits (e.g., passes, outputs, etc.) the base priority value to the example priority adjustment circuitry 810 (FIG. 8) At block 908, the example priority adjustment circuitry 810 determines whether the metric ID matches historical information. As described above in conjunction with FIG. 8, the data consumption analysis circuitry 808 tracks access to previously stored data (e.g., locally and/or at another edge computing device). Thus, if previous data corresponding to the same metric ID has already been stored (e.g., locally or at another edge device), the data consumption analysis circuitry 808 can provide information (e.g., historical information) to the priority adjustment circuitry 810 related to the access of the data after being stored. If the metric ID does not match any historical information (block 908: NO), control proceeds to block 912, as further described below. If the metric ID matches historical information (block 908: YES), control proceeds to block 910.

At block 910, the example priority adjustment circuitry 810 adjusts the base priority value of the data based on the historical data that corresponds to the metric ID. For example, if the historical data corresponding to the metric ID includes information that previously stored data with the same metric ID has been accessed frequently and/or soon after being stored, the priority adjustment circuitry 810 may increase the base priority value based on the frequency (e.g., the higher the frequency, the higher the value increase) and/or the amount of time the data was accessed after being stored (e.g., the sooner the time, the higher the value increase). At block 912, the example environmental impact determination circuitry 814 determines the environmental impact associated with storing the data 802 in different storage types based on the metric ID, information carried in the data, historically processed data, processed data from another nodes, and/or information from the example data consumption analysis circuitry 808. At block 914, the example priority adjustment circuitry 810 adjusts the base priority value based on the environmental impact. For example, the priority adjustment circuitry 810 can increase or decrease the priority value based on the environmental impact associated with storing the data 802 in each storage device. At block 916, the example priority adjustment circuitry 810 adjusts the priority value of the data 802 based on the characteristics and/or operating mode of the edge computing device 708. For example, the priority adjustment circuitry 810 can lower the priority value of the data 802 when the edge computing device 708 is operating in a low power mode and increase the priority value when the edge computing device 708 is operating in a high power mode.

At block 918, the example priority determination circuitry 810 determines whether the data 802 is a duplicate and/or whether the priority value is below a threshold (block 918). For some metric IDs, duplicate data may be discarded because they may provide little to no value to the processing system and therefore will correspond to a low likelihood that they will be accessed after stored. Accordingly, the priority determination circuitry 810 can discard such duplicate data. Additionally, if the priority value is below a particular value or threshold, the likelihood that the data will be accessed may be so low that there may be little to no risk to discarding the data. Thus, if the data 802 is a duplicate or the priority value is below a threshold (block 918: YES), the example priority determination circuitry 810 discards the data 802 (block 920) and the example instructions and/or operations 900 end. If the data 802 is not a duplicate or the priority value is not below a threshold (block 918: NO), control proceeds to block 922.

At block 922, the example storage selection circuitry 816 (FIG. 8) selects a storage device based on the adjusted priority value. For example, high priority values (e.g., priority values above a threshold amount) may be stored in the second storage device 820 and low priority values (e.g., priority value below the threshold amount) may be stored in the first storage device 818. In some examples, the data consumption analysis circuitry 808 of FIG. 8 can instruct compression circuitry to compress the data 802, if the data is below the threshold amount to further reduce the memory resources needed to store the data 802. At block 924, the example storage selection circuitry 816 stores the data 802 to the selected storage device. At block 926, the example priority adjustment circuitry 810 publishes the data metric ID with the corresponding information and/or selected storage device. For example, the priority adjustment circuitry 810 outputs the metric ID and corresponding information to other edge devices via the network interface 812. The example base priority determination circuitry 804 determines whether any other data is received (block 928). If other data is received (block 928: YES), control returns to block 902. If no other data is received (block 928: NO), the example instructions and/or operations 900 of FIG. 9 end.

FIG. 10 is a flowchart representative of example machine readable instructions and/or example operations 1000 that may be executed, instantiated, and/or performed by programmable circuitry to implement the data consumption circuitry 808 to determine track data consumption after being stored. The example machine-readable instructions and/or the example operations 1000 of FIG. 10 begin at block 1002, at which the example data consumption analysis circuitry 808 (FIG. 8) analyzes stored data.

At block 1004, the example data consumption analysis circuitry 808 groups the stored data. For example, the data consumption analysis circuitry 808 groups the stored data based on metric ID. Data corresponding to similar data type and data usage are grouped under the same metric ID so that future received data can be compared to the group of stored data to determine if it was similar to the stored data, and be assigned the same metric ID. At block 1006, the example data consumption analysis circuitry 808 analyzes the use of the stored data to make patterns associated with likelihood the received data 802 will be used sooner. For example, the data consumption analysis circuitry 808 compares the received data 802 with the stored data to identify if the received data 802 is similar to the stored data in terms of circumstances, data type. Additionally, the data consumption analysis circuitry 808 identifies how often the stored data that matches the received data 802 was used, accessed, and/or processed by an edge node based on the circumstances. This creates a pattern that is associated with the likelihood that the currently received data will be used sooner or later. At block 1008, the example data consumption analysis circuitry 808 determines whether the stored data is being accessed. For example, the edge computing device 708 may access the data to detect device failure, make decisions regarding execution of workloads, perform mitigating operations, etc. If the stored data is not being accessed (block 1008: NO), control returns to block 1002.

If the stored data is being accessed (block 1008: YES), control proceeds to block 1010, at which the example data consumption analysis circuitry 808 determines information related to the accessed data. These information may include a metric ID, a priority value, a data storage type, how long the data was stored in the memory, how many times the data has been accessed, etc. At block 1012, the example data consumption analysis circuitry 808 determines system information associated with the data. The system information includes operation mode, information from sensors, central processing unit (CPU) usage, memory usage, etc. At block 1014, the example data consumption analysis circuitry 808 associates accessed data with determined information to generate historical data information.

At block 1016, the example data consumption analysis circuitry 808 determines whether the example priority adjustment circuitry 810 is processing the incoming data similar to stored data (e.g., to determine where to store the incoming data). If the example priority adjustment circuitry 810 is not processing the incoming data similar to stored data (block 1016: NO), control returns to block 1002 at which the example data consumption analysis circuitry 808 continues analyzing, tracking, and/or monitoring the stored data. If the example priority adjustment circuitry 810 is processing the incoming data similar to stored data (block 1016: YES), control proceeds to block 1018. At block 1018, the example data consumption analysis circuitry 808 provides the relevant historical information corresponding to the incoming data (e.g., historical data corresponding to the same metric ID as the incoming data) to the example priority adjustment circuitry 810. In this manner, the priority adjustment circuitry 810 can adjust a priority value and/or select a storage type for the incoming data based on the relevant historical data. After block 1018, control returns to block 1002.

FIG. 11 is a block diagram of an example programmable circuitry platform 1100 structured to execute and/or instantiate the example machine-readable instructions and/or the example operations of FIGS. 9-10 to implement the data storage controller 710 of FIG. 8. The programmable circuitry platform 1100 can be, for example, a server, a personal computer, a workstation, a self-learning machine (e.g., a neural network), or any other type of computing and/or electronic device.

The programmable circuitry platform 1100 of the illustrated example includes programmable circuitry 1112. The programmable circuitry 1112 of the illustrated example is hardware. For example, the programmable circuitry 1112 can be implemented by one or more integrated circuits, logic circuits, FPGAs, microprocessors, CPUs, GPUs, DSPs, and/or microcontrollers from any desired family or manufacturer. The programmable circuitry 1112 may be implemented by one or more semiconductor based (e.g., silicon based) devices. In this example, the programmable circuitry 1112 implements the example base priority determination circuitry 804, the example throttling circuitry 806, the example data consumption analysis circuitry 808, the example priority adjustment circuitry 810, the example environmental impact determination circuitry 814, and the example storage selection circuitry 816.

The programmable circuitry 1112 of the illustrated example includes a local memory 1113 (e.g., a cache, registers, etc.). The programmable circuitry 1112 of the illustrated example is in communication with main memory 1114, 1116, which includes a volatile memory 1114 and a non-volatile memory 1116, by a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1116 may be implemented by flash memory and/or any other desired type of memory device. Access to the main memory 1114, 1116 of the illustrated example is controlled by a memory controller 1117. In some examples, the memory controller 1117 may be implemented by one or more integrated circuits, logic circuits, microcontrollers from any desired family or manufacturer, or any other type of circuitry to manage the flow of data going to and from the main memory 1114, 1116. In example FIG. 8, the example first storage device 818 and the second storage device 820 is implemented in non-volatile memory 1116. However, the first storage device 818 and/or the second storage device 820 may be implemented by the volatile memory 1114, the non-volatile memory 1116, and/or the mass storage discs or devices 1128.

The programmable circuitry platform 1100 of the illustrated example also includes interface circuitry 1120. In example FIG. 8, the example network interface 812 may be implemented by the interface circuitry 1120. The interface circuitry 1120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1122 are connected to the interface circuitry 1120. The input device(s) 1122 permit(s) a user (e.g., a human user, a machine user, etc.) to enter data and/or commands into the programmable circuitry 1112. The input device(s) 1122 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1124 are also connected to the interface circuitry 1120 of the illustrated example. The output device(s) 1124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1120 of the illustrated example, thus, typically includes a graphics driver card, a graphics driver chip, and/or graphics processor circuitry such as a GPU.

The interface circuitry 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1126. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1100 of the illustrated example also includes one or more mass storage discs or devices 1128 to store firmware, software, and/or data. Examples of such mass storage discs or devices 1128 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1132, which may be implemented by the machine readable instructions of FIGS. 9-10, may be stored in the mass storage device 1128, in the volatile memory 1114, in the non-volatile memory 1116, and/or on at least one non-transitory computer readable storage medium such as a CD or DVD which may be removable.

FIG. 12 is a block diagram of an example implementation of the programmable circuitry 1112 of FIG. 11. In this example, the programmable circuitry 1112 of FIG. 11 is implemented by a microprocessor 1200. For example, the microprocessor 1200 may be a general-purpose microprocessor (e.g., general-purpose microprocessor circuitry). The microprocessor 1200 executes some or all of the machine-readable instructions of the flowcharts of FIGS. 9-10 to effectively instantiate the circuitry of FIG. 2 as logic circuits to perform operations corresponding to those machine readable instructions. In some such examples, the circuitry of FIG. 8 is instantiated by the hardware circuits of the microprocessor 1200 in combination with the machine-readable instructions. For example, the microprocessor 1200 may be implemented by multi-core hardware circuitry such as a CPU, a DSP, a GPU, an XPU, etc. Although it may include any number of example cores 1202 (e.g., 1 core), the microprocessor 1200 of this example is a multi-core semiconductor device including N cores. The cores 1202 of the microprocessor 1200 may operate independently or may cooperate to execute machine readable instructions. For example, machine code corresponding to a firmware program, an embedded software program, or a software program may be executed by one of the cores 1202 or may be executed by multiple ones of the cores 1202 at the same or different times. In some examples, the machine code corresponding to the firmware program, the embedded software program, or the software program is split into threads and executed in parallel by two or more of the cores 1202. The software program may correspond to a portion or all of the machine readable instructions and/or operations represented by the flowcharts of FIGS. 9-10.

The cores 1202 may communicate by a first example bus 1204. In some examples, the first bus 1204 may be implemented by a communication bus to effectuate communication associated with one(s) of the cores 1202. For example, the first bus 1204 may be implemented by at least one of an Inter-Integrated Circuit (I2C) bus, a Serial Peripheral Interface (SPI) bus, a PCI bus, or a PCIe bus. Additionally or alternatively, the first bus 1204 may be implemented by any other type of computing or electrical bus. The cores 1202 may obtain data, instructions, and/or signals from one or more external devices by example interface circuitry 1206. The cores 1202 may output data, instructions, and/or signals to the one or more external devices by the interface circuitry 1206. Although the cores 1202 of this example include example local memory 1220 (e.g., Level 1 (L1) cache that may be split into an L1 data cache and an L1 instruction cache), the microprocessor 1200 also includes example shared memory 1210 that may be shared by the cores (e.g., Level 2 (L2 cache)) for high-speed access to data and/or instructions. Data and/or instructions may be transferred (e.g., shared) by writing to and/or reading from the shared memory 1210. The local memory 1220 of each of the cores 1202 and the shared memory 1210 may be part of a hierarchy of storage devices including multiple levels of cache memory and the main memory (e.g., the main memory 1114, 1116 of FIG. 11). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1202 may be referred to as a CPU, DSP, GPU, etc., or any other type of hardware circuitry. Each core 1202 includes control unit circuitry 1214, arithmetic and logic (AL) circuitry (sometimes referred to as an ALU) 1216, a plurality of registers 1218, the local memory 1220, and a second example bus 1222. Other structures may be present. For example, each core 1202 may include vector unit circuitry, single instruction multiple data (SIMD) unit circuitry, load/store unit (LSU) circuitry, branch/jump unit circuitry, floating-point unit (FPU) circuitry, etc. The control unit circuitry 1214 includes semiconductor-based circuits structured to control (e.g., coordinate) data movement within the corresponding core 1202. The AL circuitry 1216 includes semiconductor-based circuits structured to perform one or more mathematic and/or logic operations on the data within the corresponding core 1202. The AL circuitry 1216 of some examples performs integer based operations. In other examples, the AL circuitry 1216 also performs floating-point operations. In yet other examples, the AL circuitry 1216 may include first AL circuitry that performs integer-based operations and second AL circuitry that performs floating-point operations. In some examples, the AL circuitry 1216 may be referred to as an Arithmetic Logic Unit (ALU).

The registers 1218 are semiconductor-based structures to store data and/or instructions such as results of one or more of the operations performed by the AL circuitry 1216 of the corresponding core 1202. For example, the registers 1218 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1218 may be arranged in a bank as shown in FIG. 12. Alternatively, the registers 1218 may be organized in any other arrangement, format, or structure, such as by being distributed throughout the core 1202 to shorten access time. The second bus 1222 may be implemented by at least one of an I2C bus, a SPI bus, a PCI bus, or a PCIe bus.

Each core 1202 and/or, more generally, the microprocessor 1200 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1200 is a semiconductor device fabricated to include many transistors interconnected to implement the structures described above in one or more integrated circuits (ICs) contained in one or more packages.

The microprocessor 1200 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1200, in the same chip package as the microprocessor 1200 and/or in one or more separate packages from the microprocessor 1200.

FIG. 13 is a block diagram of another example implementation of the programmable circuitry 1112 of FIG. 11. In this example, the programmable circuitry 1112 is implemented by FPGA circuitry 1300. For example, the FPGA circuitry 1300 may be implemented by an FPGA. The FPGA circuitry 1300 can be used, for example, to perform operations that could otherwise be performed by the example microprocessor 1200 of FIG. 12 executing corresponding machine readable instructions. However, once configured, the FPGA circuitry 1300 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1200 of FIG. 12 described above (which is a general purpose device that may be programmed to execute some or all of the machine readable instructions represented by the flowchart(s) of FIGS. 9-10 but whose interconnections and logic circuitry are fixed once fabricated), the FPGA circuitry 1300 of the example of FIG. 13 includes interconnections and logic circuitry that may be configured, structured, programmed, and/or interconnected in different ways after fabrication to instantiate, for example, some or all of the operations/functions corresponding to the machine readable instructions represented by the flowcharts of FIGS. 9-10. In particular, the FPGA circuitry 1300 may be thought of as an array of logic gates, interconnections, and switches. The switches can be programmed to change how the logic gates are interconnected by the interconnections, effectively forming one or more dedicated logic circuits (unless and until the FPGA circuitry 1300 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 9-10. As such, the FPGA circuitry 1300 may be configured and/or structured to effectively instantiate some or all of the operations/functions corresponding to the machine readable instructions of the flowchart(s) of FIGS. 9-10 as dedicated logic circuits to perform the operations/functions corresponding to those software instructions in a dedicated manner analogous to an ASIC. Therefore, the FPGA circuitry 1300 may perform the operations/functions corresponding to the some or all of the machine readable instructions of FIGS. 9-10 faster than the general-purpose microprocessor can execute the same.

In the example of FIG. 13, the FPGA circuitry 1300 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1300 of FIG. 13 may access and/or load the binary file to cause the FPGA circuitry 1300 of FIG. 13 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1300 of FIG. 13 to cause configuration and/or structuring of the FPGA circuitry 1300 of FIG. 13, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1300 of FIG. 13 may access and/or load the binary file to cause the FPGA circuitry 1300 of FIG. 13 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1300 of FIG. 13 to cause configuration and/or structuring of the FPGA circuitry 1300 of FIG. 13, or portion(s) thereof.

The FPGA circuitry 1300 of FIG. 13, includes example input/output (I/O) circuitry 1302 to obtain and/or output data to/from example configuration circuitry 1304 and/or external hardware 1306. For example, the configuration circuitry 1304 may be implemented by interface circuitry that may obtain a binary file, which may be implemented by a bit stream, data, and/or machine-readable instructions, to configure the FPGA circuitry 1300, or portion(s) thereof. In some such examples, the configuration circuitry 1304 may obtain the binary file from a user, a machine (e.g., hardware circuitry (e.g., programmable, or dedicated circuitry) that may implement an Artificial Intelligence/Machine Learning (AI/ML) model to generate the binary file), etc., and/or any combination(s) thereof). In some examples, the external hardware 1306 may be implemented by external hardware circuitry. For example, the external hardware 1306 may be implemented by the microprocessor 1200 of FIG. 12.

The FPGA circuitry 1300 also includes an array of example logic gate circuitry 1308, a plurality of example configurable interconnections 1310, and example storage circuitry 1312. The logic gate circuitry 1308 and the configurable interconnections 1310 are configurable to instantiate one or more operations/functions that may correspond to at least some of the machine readable instructions of FIGS. 9-10 and/or other desired operations. The logic gate circuitry 1308 shown in FIG. 13 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1308 to enable configuration of the electrical structures and/or the logic gates to form circuits to perform desired operations/functions. The logic gate circuitry 1308 may include other electrical structures such as look-up tables (LUTs), registers (e.g., flip-flops or latches), multiplexers, etc.

The configurable interconnections 1310 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1308 to program desired logic circuits.

The storage circuitry 1312 of the illustrated example is structured to store result(s) of the one or more of the operations performed by corresponding logic gates. The storage circuitry 1312 may be implemented by registers or the like. In the illustrated example, the storage circuitry 1312 is distributed amongst the logic gate circuitry 1308 to facilitate access and increase execution speed.

The example FPGA circuitry 1300 of FIG. 13 also includes example dedicated operations circuitry 1314. In this example, the dedicated operations circuitry 1314 includes special purpose circuitry 1316 that may be invoked to implement commonly used functions to avoid the need to program those functions in the field. Examples of such special purpose circuitry 1316 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1300 may also include example general purpose programmable circuitry 1318 such as an example CPU 1320 and/or an example DSP 1322. Other general purpose programmable circuitry 1318 may additionally or alternatively be present such as a GPU, an XPU, etc., that can be programmed to perform other operations.

Although FIGS. 12 and 13 illustrate two example implementations of the programmable circuitry 1112 of FIG. 11, many other approaches are contemplated. For example, FPGA circuitry may include an on-board CPU, such as one or more of the example CPU 1320 of FIG. 12. Therefore, the programmable circuitry 1112 of FIG. 11 may additionally be implemented by combining at least the example microprocessor 1200 of FIG. 12 and the example FPGA circuitry 1300 of FIG. 13. In some such hybrid examples, one or more cores 1202 of FIG. 12 may execute a first portion of the machine readable instructions represented by the flowchart(s) of FIGS. 9-10 to perform first operation(s)/function(s), the FPGA circuitry 1300 of FIG. 13 may be configured and/or structured to perform second operation(s)/function(s) corresponding to a second portion of the machine readable instructions represented by the flowcharts of FIG. 9-10, and/or an ASIC may be configured and/or structured to perform third operation(s)/function(s) corresponding to a third portion of the machine readable instructions represented by the flowcharts of FIGS. 9-10.

It should be understood that some or all of the circuitry of FIG. 8 may, thus, be instantiated at the same or different times. For example, same and/or different portion(s) of the microprocessor 1200 of FIG. 12 may be programmed to execute portion(s) of machine-readable instructions at the same and/or different times. In some examples, same and/or different portion(s) of the FPGA circuitry 1300 of FIG. 13 may be configured and/or structured to perform operations/functions corresponding to portion(s) of machine-readable instructions at the same and/or different times.

In some examples, some or all of the circuitry of FIG. 8 may be instantiated, for example, in one or more threads executing concurrently and/or in series. For example, the microprocessor 1200 of FIG. 12 may execute machine readable instructions in one or more threads executing concurrently and/or in series. In some examples, the FPGA circuitry 1300 of FIG. 13 may be configured and/or structured to carry out operations/functions concurrently and/or in series. Moreover, in some examples, some or all of the circuitry of FIG. 8 may be implemented within one or more virtual machines and/or containers executing on the microprocessor 1200 of FIG. 12.

In some examples, the programmable circuitry 1112 of FIG. 11 may be in one or more packages. For example, the microprocessor 1200 of FIG. 12 and/or the FPGA circuitry 1300 of FIG. 13 may be in one or more packages. In some examples, an XPU may be implemented by the programmable circuitry 1112 of FIG. 11, which may be in one or more packages. For example, the XPU may include a CPU (e.g., the microprocessor 1200 of FIG. 12, the CPU 1320 of FIG. 13, etc.) in one package, a DSP (e.g., the DSP 1322 of FIG. 13) in another package, a GPU in yet another package, and an FPGA (e.g., the FPGA circuitry 1300 of FIG. 13) in still yet another package.

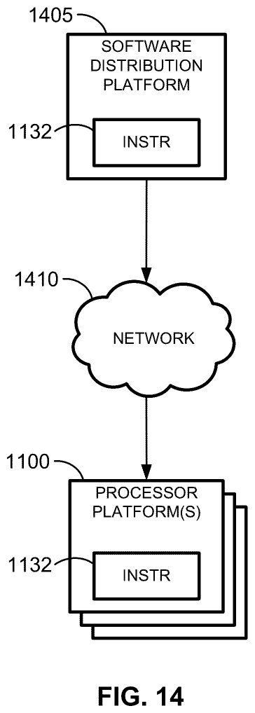

A block diagram illustrating an example software distribution platform 1405 to distribute software such as the example machine readable instructions 1132 of FIG. 11 to other hardware devices (e.g., hardware devices owned and/or operated by third parties from the owner and/or operator of the software distribution platform) is illustrated in FIG. 14. The example software distribution platform 1405 may be implemented by any computer server, data facility, cloud service, etc., capable of storing and transmitting software to other computing devices. The third parties may be customers of the entity owning and/or operating the software distribution platform 1405. For example, the entity that owns and/or operates the software distribution platform 1405 may be a developer, a seller, and/or a licensor of software such as the example machine readable instructions 1132 of FIG. 11. The third parties may be consumers, users, retailers, OEMs, etc., who purchase and/or license the software for use and/or re-sale and/or sub-licensing. In the illustrated example, the software distribution platform 1405 includes one or more servers and one or more storage devices. The storage devices store the machine readable instructions 1132, which may correspond to the example machine readable instructions of FIGS. 9-10, as described above. The one or more servers of the example software distribution platform 1405 are in communication with an example network 1410, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1132 from the software distribution platform 1405. For example, the software, which may correspond to the example machine readable instructions of FIG. 9-10, may be downloaded to the example programmable circuitry platform 1100, which is to execute the machine readable instructions 1132 to implement the [ER-Apparatus]. In some examples, one or more servers of the software distribution platform 1405 periodically offer, transmit, and/or force updates to the software (e.g., the example machine readable instructions 1132 of FIG. 11) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that store data based on environmental impact of storage device. Disclosed systems, apparatus, articles of manufacture, and methods improve the efficiency of using a computing device by implementing a data storage controller to determine where to store received and/or generated data based on an environmental impact corresponding to one or more storage devices. By processing the data to determine where to store the data, examples disclosed herein result in more memory efficient edge devices that have a smaller environmental impact on the world. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to store data based on environmental impact of storage device are disclosed herein. Further examples and combinations thereof include the following: Example 1 includes an apparatus to store data, the apparatus comprising interface circuitry, machine readable instructions, and programmable circuitry to at least one of instantiate or execute the machine readable instructions to determine a first environmental impact associated with storing the data in a first storage device, determine a second environmental impact associated with storing the data in a second storage device, and cause the data to be stored in one of the first storage device or the second storage device based on the first environmental impact and the second environmental impact.

Example 2 includes the apparatus of example 1, wherein the programmable circuitry is to generate a metric identifier (ID) and base priority value to the data based on a data type of the data.

Example 3 includes the apparatus of example 1 or 2, wherein the programmable circuitry is to adjust the base priority value based on at least one of 1) historical information corresponding to the metric ID, or 2) the first or second environmental impact associated with storing the data in the first storage device or the second storage device.

Example 4 includes the apparatus of example 1, 2, or 3, wherein the programmable circuitry is to determine that the data corresponds to stored data, the stored data stored into at least one of the first storage device or the second storage device prior to the data, and cause the data to be stored in the one of the first storage device or the second storage device based on historical information corresponding to the stored data.

Example 5 includes the apparatus of example 1, 2, 3, or 4, wherein the stored data includes at least one of 1) a metric identifier (ID), 2) a priority value, 3) a storage device type, or 4) information related to a system.

Example 6 includes the apparatus of example 1, 2, 3, 4, or 5, wherein the programmable circuitry is to track the stored data to generate historical information.

Example 7 includes the apparatus of example 1, 2, 3, 4, 5, or 6, wherein the stored data is first stored data, the programmable circuitry to cluster the stored data with second stored data using a k-nearest neighbors (KNN) algorithm.

Example 8 includes the apparatus of example 1, 2, 3, 4, 5, 6 or 7, wherein the stored data is stored in a peer edge node.

Example 9 includes the apparatus of example 1, 2, 3, 4, 5, 6, 7, and/or 8, wherein the first environmental impact corresponds to at least one of a generation, a use, or a disposal of the first storage device.

Example 10 includes the apparatus of example 1, 2, 3, 4, 5, 6, 7, 8 and/or 9, wherein the first environmental impact corresponds to greenhouse gas emissions related to the first storage device.

Example 11 includes the apparatus of example 1, 2, 3, 4, 5, 6, 7, 8, 9 and/or 10, further including transport circuitry, wherein the environmental impact corresponds to the transportation of the data via the transport circuitry.

Example 12 includes a non-transitory machine readable storage medium comprising instructions to cause programmable circuitry to at least determine a first environmental impact associated with writing data in a first storage device, determine a second environmental impact associated with writing the data in a second storage device, and cause the data to be written to one of the first storage device or the second storage device based on the first environmental impact and the second environmental impact.

Example 13 includes the non-transitory machine readable storage medium of example 12, wherein the instructions are to cause the programmable circuitry to generate a metric identifier (ID) and base priority value to the data based on a data type of the data.

Example 14 includes the non-transitory machine readable storage medium of example 12 or 13, wherein the instructions are to cause the programmable circuitry to adjust the base priority value based on at least one of 1) historical information corresponding to the metric ID, or 2) the first or second environmental impact associated with writing the data in the first storage device or the second storage device.

Example 15 includes the non-transitory machine readable storage medium of example 12, 13, or 14, wherein the instructions are to cause the programmable circuitry to discard the data based on at least one of 1) the data being a duplicative, or 2) the corresponding to a priority value below a threshold.

Example 16 includes the non-transitory machine readable storage medium of example 12, 13, 14, or 15, wherein the instructions are to cause the programmable circuitry to determine that the data corresponds to stored data the stored data including at least one of 1) a metric identifier (ID), 2) a priority value, 3) a storage device type, or 4) information related to a system, and the stored data written to at least one of the first storage device or the second storage device prior to the data, and cause the data to be written to the one of the first storage device or the second storage device based on historical information corresponding to the stored data.

Example 17 includes the non-transitory machine readable storage medium of example 12, 13, 14, 15, or 16, wherein the instructions are to cause the programmable circuitry to track the stored data to generate historical information.

Example 18 includes the non-transitory machine readable storage medium of example 12, 13, 14, 15, 16, or 17, wherein the stored data is first stored data, and the instructions are to cause the programmable circuitry to cluster the stored data with second stored data using a k-nearest neighbors (KNN) algorithm.

Example 19 includes the non-transitory machine readable storage medium of example 12, 13, 14, 15, 16, 17, or 18, wherein the data is telemetry data.

Example 20 includes a method comprising determining a first environmental impact associated with storing a data in first memory, determining a second environmental impact associated with storing the data in second memory, and causing the data to be stored in one of the first memory or the second memory based on the first environmental impact and the second environmental impact.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus to store data, the apparatus comprising:
interface circuitry;
machine readable instructions; and
programmable circuitry to at least one of instantiate or execute the machine readable instructions to:
determine a first environmental impact associated with storing the data in a first storage device;
determine a second environmental impact associated with storing the data in a second storage device; and
cause the data to be stored in one of the first storage device or the second storage device based on the first environmental impact and the second environmental impact.

2. The apparatus of claim 1, wherein the programmable circuitry is to generate a metric identifier (ID) and base priority value to the data based on a data type of the data.

3. The apparatus of claim 2, wherein the programmable circuitry is to adjust the base priority value based on at least one of 1) historical information corresponding to the metric ID, or 2) the first or second environmental impact associated with storing the data in the first storage device or the second storage device.

4. The apparatus of claim 1, wherein the programmable circuitry is to:
determine that the data corresponds to stored data, the stored data stored into at least one of the first storage device or the second storage device prior to the data; and
cause the data to be stored in the one of the first storage device or the second storage device based on historical information corresponding to the stored data.

5. The apparatus of claim 4, wherein the stored data includes at least one of 1) a metric identifier (ID), 2) a priority value, 3) a storage device type, or 4) information related to a system.

6. The apparatus of claim 4, wherein the programmable circuitry is to track the stored data to generate historical information.

7. The apparatus of claim 4, wherein the stored data is first stored data, the programmable circuitry to cluster the stored data with second stored data using a k-nearest neighbors (KNN) algorithm.

8. The apparatus of claim 4, wherein the stored data is stored in a peer edge node.

9. The apparatus of claim 1, wherein the first environmental impact corresponds to at least one of a generation, a use, or a disposal of the first storage device.

10. The apparatus of claim 1, wherein the first environmental impact corresponds to greenhouse gas emissions related to the first storage device.

11. The apparatus of claim 1, further including transport circuitry, wherein the environmental impact corresponds to the transportation of the data via the transport circuitry.

12. A non-transitory machine readable storage medium comprising instructions to cause programmable circuitry to at least:
determine a first environmental impact associated with writing data in a first storage device;
determine a second environmental impact associated with writing the data in a second storage device; and
cause the data to be written to one of the first storage device or the second storage device based on the first environmental impact and the second environmental impact.

13. The non-transitory machine readable storage medium of claim 12, wherein the instructions are to cause the programmable circuitry to generate a metric identifier (ID) and base priority value to the data based on a data type of the data.

14. The non-transitory machine readable storage medium of claim 13, wherein the instructions are to cause the programmable circuitry to adjust the base priority value based on at least one of 1) historical information corresponding to the metric ID, or 2) the first or second environmental impact associated with writing the data in the first storage device or the second storage device.

15. The non-transitory machine readable storage medium of claim 12, wherein the instructions are to cause the programmable circuitry to discard the data based on at least one of 1) the data being a duplicative, or 2) the data corresponding to a priority value below a threshold.

16. The non-transitory machine readable storage medium of claim 12, wherein the instructions are to cause the programmable circuitry to:
determine that the data corresponds to stored data, the stored data including at least one of 1) a metric identifier (ID), 2) a priority value, 3) a storage device type, or 4) information related to a system, and the stored data written to at least one of the first storage device or the second storage device prior to the data; and
cause the data to be written to the one of the first storage device or the second storage device based on historical information corresponding to the stored data.

17. The non-transitory machine readable storage medium of claim 16, wherein the instructions are to cause the programmable circuitry to track the stored data to generate historical information.

18. The non-transitory machine readable storage medium of claim 16, wherein the stored data is first stored data, and the instructions are to cause the programmable circuitry to cluster the stored data with second stored data using a k-nearest neighbors (KNN) algorithm.

19. The non-transitory machine readable storage medium of claim 12, wherein the data is telemetry data.

20. A method comprising:
determining a first environmental impact associated with storing a data in first memory;
determining a second environmental impact associated with storing the data in second memory; and
causing the data to be stored in one of the first memory or the second memory based on the first environmental impact and the second environmental impact.
